(19) United States
(12) Patent Application Publication
(10) Pub. No.: US 2024/0244435 A1
(43) Pub. Date: Jul. 18, 2024

(54) Integrity Protection of Acknowledgment Response in a Wireless Communication Network

(71) Applicant: Telefonaktiebolaget LM Ericsson (pub), Stockholm (SE)

(72) Inventors: Christine Jost, Dalby (SE); Noamen Ben Henda, Vällingby (SE); David Castellanos Zamora, Madrid (ES); Peter Hedman, Helsingborg (SE); Ivo Sedlacek, Hovorcovice (CZ); Vlasios Tsiatsis, Stockholm (SE); Monica Wifvesson, Lund (SE)

(21) Appl. No.: 18/554,296

(22) PCT Filed: Apr. 14, 2022
(86) PCT No.: PCT/EP2022/060052

§ 371 Date: Oct. 6, 2023

Related U.S. Application Data
(60) Provisional application No. 63/176,880, filed on Apr. 19, 2021.

(51) Int. Cl. H04W 12/106

(52) U.S. Cl. CPC H04W 12/106

(57) ABSTRACT

An authentication server (10A) is configured for use in a home network (10H) of a wireless device (12). The authentication server (10A) generates expected integrity protection data for checking an integrity of a set of one or more information fields (22) contained in a transparent container (20) that acknowledges successful reception by the wireless device (12) of device configuration data (14) from the home network (10H). The authentication server (10A) checks, or assists a core network node (16H) in the home network (10H) to check, the integrity of the set of one or more information fields (22) using the expected integrity protection data.

### TECHNICAL FIELD

The present application relates generally to a wireless communication network, and relates more particularly to integrity protection of an acknowledgement response in such a network.

### BACKGROUND

A wireless device's home network may under some circumstances send configuration data to the wireless device. The wireless device may correspondingly acknowledge successful reception of that configuration data. Heretofore, integrity protection checking of the wireless device's acknowledgement is based on a message authentication code (MAC) that is precomputed, before the wireless device even sends the acknowledgement. This precomputation of the MAC proves efficient from a resource usage and signaling perspective, but limits the ability of the device's acknowledgement to securely convey any other information.

### SUMMARY

Some embodiments herein advantageously integrity protect a set of information field(s) contained in a transparent container that acknowledges a wireless device's successful reception of device configuration data from the device's home network. Some embodiments notably check the integrity of the set of information field(s) using expected integrity protection data that is generated based on the transparent container or the set of information field(s), e.g., so as to account for the actual transparent container or information field(s) sent. That is, rather than precomputing the expected integrity protection data, some embodiments reactively generate the expected integrity protection data. These and other embodiments, then, advantageously enable the transparent container to be exploited for conveying other information securely to the home network besides just the acknowledgement of successful reception of the device configuration data.

More particularly, embodiments herein include a method performed by an authentication server configured for use in a home network of a wireless device. The method comprises generating expected integrity protection data for checking an integrity of a set of one or more information fields contained in a transparent container that acknowledges successful reception by the wireless device of device configuration data from the home network. The method also comprises checking, or assisting a core network node in the home network to check, the integrity of the set of one or more information fields using the expected integrity protection data.

In some embodiments, the transparent container contains a header and a body. In some embodiments, the header includes at least one information field in the set of one or more information fields, with said generating comprises generating the expected integrity protection data from the at least one information field included in the header. Additionally or alternatively in other embodiments, the body includes at least one information field in the set of one or more information fields, wherein said generating comprises generating the expected integrity protection data from the at least one information field included in the body. In one or more of these embodiments, the expected integrity protection data from the at least one information field included in the header comprises generating the expected integrity protection data from the header. In one or more of these embodiments, the body includes the integrity protection data. In some embodiments, generating the expected integrity protection data from the at least one information field included in the body comprises generating the expected integrity protection data from all of the body except the integrity protection data.

In some embodiments, said generating comprises generating the expected integrity protection data from the whole transparent container except for the integrity protection data.

In some embodiments, the device configuration data includes steering of roaming information, wherein the steering of roaming information comprises information for encouraging the wireless device to roam to a preferred roamed-to-network indicated by the home network. Additionally or alternatively, the device configuration data includes an information field that indicates the wireless device supports steering of roaming connected mode control information. In some embodiments, the steering of roaming connected mode control information comprises information to control timing for the wireless device to move from connected mode to idle mode in order to perform steering of roaming.

In some embodiments, the device configuration data includes a set of one or more device parameters. In some embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields includes an information field indicating that, or whether, the wireless device supports a certain device parameter from the home network. Additionally or alternatively, the set of one or more information fields includes a field indicating that, or whether, the wireless device supports a certain parameter for User Equipment (UE) Parameter Update (UPU).

In some embodiments, said generating comprises generating the expected integrity protection data from the set of one or more information fields.

In some embodiments, generating the expected integrity protection data comprises forming an input to a key derivation function from a set of input parameters. In some embodiments, the set of input parameters includes at least the set of one or more information fields. Generating the expected integrity protection data also comprises calculating an output of the key derivation function with the formed input. Generating the expected integrity protection data also comprises generating the expected integrity protection data from the output of the key derivation function.

In some embodiments, the method further comprises receiving the transparent container, or the set of one or more information fields, from the core network node, as received by the core network node from the wireless device. In one or more of these embodiments, said generating comprises generating the expected integrity protection data from the transparent container, or the set of one or more information fields, received from the core network node.

In some embodiments, said generating comprises generating the expected integrity protection data after the home network receives the transparent container from the wireless device.

In some embodiments, said generating comprises, before the home network receives the transparent container from the wireless device, generating the expected integrity protection data from an expected transparent container, or an expected set of one or more information fields, that is expected to be received by the home network from the wireless device.

In some embodiments, said checking, or assisting a core network node in the home network to check, the integrity of the set of one or more information fields comprises checking the integrity of the set of one or more information fields. In some embodiments, the method further comprises transmitting, to the core network node in the home network, information indicating a result of said checking. Alternatively, said checking, or assisting a core network node in the home network to check, the integrity of the set of one or more information fields comprises assisting the core network node to check the integrity of the set of one or more information fields. In some embodiments, said assisting comprises transmitting the expected integrity protection data to the core network node.

In some embodiments, the home network could be a Home Public Land Mobile Network (HPLMN) or an Non-Public Network (NPN), e.g. Standalone NPN (SNPN).

Other embodiments herein include a method performed by a core network node configured for use in a home network of a wireless device. The method comprises transmitting, from the core network node to an authentication server in the home network, a transparent container or a set of one or more information fields contained in the transparent container. In some embodiments, the transparent container acknowledges successful reception by the wireless device of device configuration data from the home network. The method also comprises receiving, from the authentication server, integrity checking information. In some embodiments, the integrity checking information indicates a result of a check by the authentication server of the integrity of the set of one or more information fields. Alternatively, the integrity checking information is usable by the core network node to check the integrity of the set of one or more information fields.

In some embodiments, the integrity checking information indicates the result of a check by the authentication server of the integrity of the set of one or more information fields.

In some embodiments, the integrity checking information is usable by the core network node to check the integrity of the set of one or more information fields. In some embodiments, the method further comprises using the integrity checking information to check the integrity of the set of one or more information fields. In one or more of these embodiments, the integrity checking information comprises expected integrity protection data. In some embodiments, said using comprises checking whether the expected integrity protection data corresponds to the integrity protection data contained in the transparent container.

In some embodiments, the transparent container contains a header and a body. In some embodiments, the header includes at least one information field in the set of one or more information fields. In some embodiments, the integrity protection data protects the integrity of the set of one or more information fields by integrity protecting the at least one information field included in the header. Additionally or alternatively, the body includes at least one information field in the set of one or more information fields. In some embodiments, the integrity protection data protects the integrity of the set of one or more information fields by integrity protecting the at least one information field included in the body.

In some embodiments, the device configuration data includes steering of roaming information. In some embodiments, the steering of roaming information comprises information for encouraging the wireless device to roam to a preferred roamed-to-network indicated by the home network. Additionally or alternatively, the device configuration data includes an information field that indicates the wireless device supports steering of roaming connected mode control information. In some embodiments, the steering of roaming connected mode control information comprises information to control timing for the wireless device to move from connected mode to idle mode in order to perform steering of roaming.

In some embodiments, the device configuration data includes a set of one or more device parameters. In some embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields includes an information field indicating that, or whether, the wireless device supports a certain device parameter from the home network. Additionally or alternatively, the set of one or more information fields includes a field indicating that, or whether, the wireless device supports a certain parameter for UPU.

In some embodiments, the home network could be a Home Public Land Mobile Network (HPLMN) or an Non-Public Network (NPN), e.g. Standalone NPN (SNPN).

Other embodiments herein include a method performed by a wireless device. The method comprises receiving device configuration data from a home network of the wireless device. The method also comprises transmitting a transparent container that acknowledges successful reception of the device configuration data, contains a set of one or more information fields, and contains integrity protection data that integrity protects the set of one or more information fields.

In some embodiments, the set of one or more information fields includes an information field indicating that, or whether, the wireless device supports a certain device parameter from the home network. Additionally or alternatively, the set of one or more information fields includes a field indicating that, or whether, the wireless device supports a certain parameter for UPU.

In some embodiments, the home network could be a Home Public Land Mobile Network (HPLMN) or an Non-Public Network (NPN), e.g. Standalone NPN (SNPN).

Other embodiments herein include an authentication server configured for use in a home network of a wireless device. The authentication server comprises communication circuitry and processing circuitry. The processing circuitry is configured to generate expected integrity protection data for checking an integrity of a set of one or more information fields contained in a transparent container that acknowledges successful reception by the wireless device of device configuration data from the home network. The processing circuitry is also configured to check, or assist a core network node in the home network to check, the integrity of the set of one or more information fields using the expected integrity protection data.

In some embodiments, the processing circuitry is configured to perform the steps described above for an authentication server.

In some embodiments, the home network could be a Home Public Land Mobile Network (HPLMN) or an Non-Public Network (NPN), e.g. Standalone NPN (SNPN).

Other embodiments herein include a core network node configured for use in a home network of a wireless device. The core network node comprises communication circuitry and processing circuitry. The processing circuitry is configured to transmit, from the core network node to an authentication server in the home network, a transparent container or a set of one or more information fields contained in the transparent container. In some embodiments, the transparent container acknowledges successful reception by the wireless device of device configuration data from the home network. The processing circuitry is also configured to receive, from the authentication server, integrity checking information. In some embodiments, the integrity checking information indicates a result of a check by the authentication server of the integrity of the set of one or more information fields. Alternatively, the integrity checking information is usable by the core network node to check the integrity of the set of one or more information fields.

In some embodiments, the processing circuitry is configured to perform the steps described above for a core network node.

In some embodiments, the home network could be a Home Public Land Mobile Network (HPLMN) or an Non-Public Network (NPN), e.g. Standalone NPN (SNPN).

Other embodiments herein include a wireless device. The wireless device comprises communication circuitry and processing circuitry. The processing circuitry is configured to receive device configuration data from a home network of the wireless device. The processing circuitry is also configured to transmit a transparent container that acknowledges successful reception of the device configuration data, contains a set of one or more information fields, and contains integrity protection data that integrity protects the set of one or more information fields.

In some embodiments, the set of one or more information fields includes an information field indicating that, or whether, the wireless device supports a certain device parameter from the home network. Additionally or alternatively, the set of one or more information fields includes a field indicating that, or whether, the wireless device supports a certain parameter for UPU.

In some embodiments, the home network could be a Home Public Land Mobile Network (HPLMN) or an Non-Public Network (NPN), e.g. Standalone NPN (SNPN).

Other embodiments herein include a computer program comprising instructions which, when executed by at least one processor of an authentication server, causes the authentication server to perform the steps described above for an authentication server. Other embodiments herein include a computer program comprising instructions which, when executed by at least one processor of a core network node, causes the core network node to perform the steps described above for a core network node. Other embodiments herein include a computer program comprising instructions which, when executed by at least one processor of a wireless device, causes the wireless device to perform the steps described above for a wireless device. In one or more of these embodiments a carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless device, a serving network, and a home network according to some embodiments.

FIG. 2A is a block diagram of a transparent container according to some embodiments.

FIG. 2B is a block diagram of a transparent container according to other embodiments.

FIG. 2C is a block diagram of an PLMN ID and access technology list according to some embodiments.

FIG. 2D is a block diagram of a SOR header according to some embodiments.

FIG. 3A is a block diagram of a transparent container that contains a header, with the header including at least one information field in the set of one or more information fields that is integrity protected, according to some embodiments.

FIG. 3B is a block diagram of a transparent container that contains a body, with the body including at least one information field in the set of one or more information fields that is integrity protected, according to some embodiments.

FIG. 3C is a block diagram of a transparent container that contains a header and a body, with the header and the body each including at least one information field in the set of one or more information fields that is integrity protected, according to some embodiments.

FIG. 4A is a block diagram of a transparent container where the device configuration data includes SOR information according to some embodiments.

FIG. 4B is a block diagram of a transparent container where the device configuration data includes SOR information according to other embodiments.

FIG. 5 is a call flow diagram of a procedure heretofore for providing a list of preferred PLMN/access technology combinations after registration.

FIG. 6 is a call flow diagram of a procedure in which a SoR/UPU acknowledgement response is integrity protected when the UE includes additional information in the response, according to some embodiments.

FIG. 7 is a call flow diagram of a procedure in which the AUSF sends two XMAC values depending on the UE Ack message, according to some embodiments.

FIG. 8 is a call flow diagram of a procedure in which a SoR/UPU acknowledgement response is protected when the UE includes additional information in the response, according to other embodiments.

FIG. 9 is a logic flow diagram of a method performed by a wireless device, according to some embodiments.

FIG. 10A is a logic flow diagram of a method performed by an authentication server configured for use in a home network of a wireless device, according to some embodiments.

FIG. 10B is a logic flow diagram of a method performed by an authentication server configured for use in a home network of a wireless device, according to other embodiments.

FIG. 11A is a logic flow diagram of a method performed by a core network node configured for use in a home network of a wireless device, according to some embodiments.

FIG. 11B is a logic flow diagram of a method performed by a core network node configured for use in a home network of a wireless device, according to other embodiments.

FIG. 11C is a logic flow diagram of a method performed by a core network node configured for use in a home network of a wireless device, according to yet other embodiments.

FIG. 12 is a block diagram of a wireless device according to some embodiments.

FIG. 13 is a block diagram of an authentication server according to some embodiments.

FIG. 14 is a block diagram of a core network node according to some embodiments.

FIG. 15 is a block diagram of a wireless communication network according to some embodiments.

FIG. 16 is a block diagram of a user equipment according to some embodiments.

FIG. 17 is a block diagram of a virtualization environment according to some embodiments.

### DETAILED DESCRIPTION

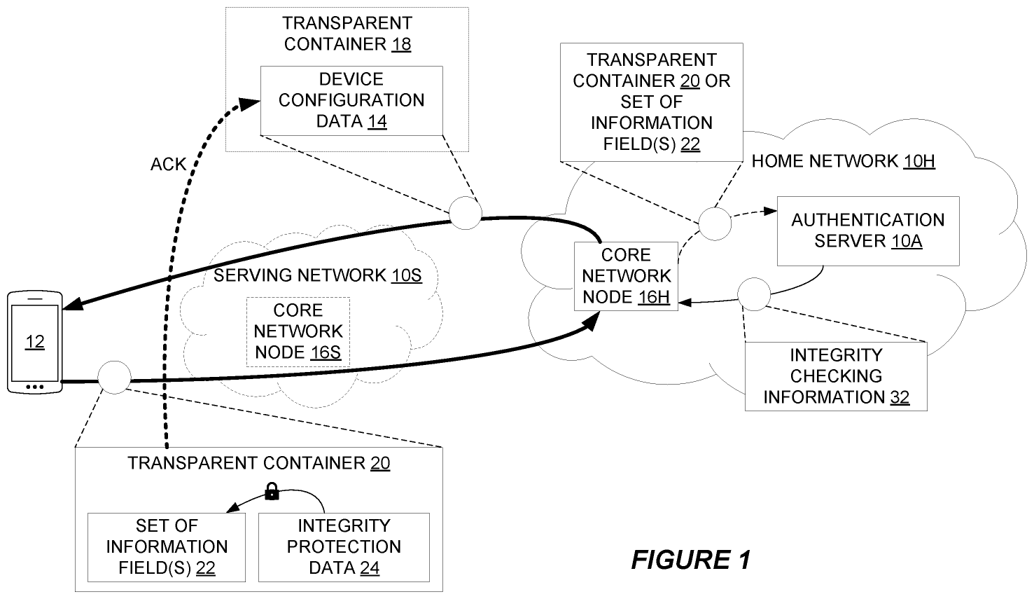

FIG. 1 shows a wireless device 12 according to some embodiments. The wireless device 12 has a home wireless communication network 10H, also referred to simply as a home network 10H. The home network 10H could be a Home Public Land Mobile Network (HPLMN) or an Non-Public Network (NPN), e.g. Standalone NPN (SNPN). The wireless device 12 in this regard may have a subscription to receive wireless communication service from the home network 10H. At any given time, though, the wireless device 12 is served by a serving wireless communication network 10S, also referred to simply as a serving network 10S. The serving network 10S may or may not be the same network as the home network 10H. The serving network 10S may for example be a visited wireless communication network to which the wireless device 12 has roamed under a roaming agreement between the home network 10H and the serving network 10S.

As shown, the wireless device 12 receives device configuration data 14 from the home network 10H. The wireless device 12 may for example receive the device configuration data 14 from core network node 16H in the home network 10H, e.g., implementing a Unified Data Management (UDM) function. In some embodiments, the device configuration data 14 includes steering of roaming (SOR) information. SOR information in this regard comprises information for encouraging the wireless device 12 to roam to a preferred roamed-to-network indicated by the home network 10H. The SOR information may for example comprise a list of preferred Public Land Mobile Network (PLMN)/access technology combinations that is preferred by the home network 10H.

In other embodiments, the device configuration data 14 includes a set of one or more device parameters, e.g., with which the wireless device 12 is to be configured by the home network 10H. For example, the set of one or more device parameters may include a parameter that indicates default configured network slice selection assistance information (NSSAI) and/or a parameter that indicates routing indicator data. In one such embodiment, the device configuration data 14 includes User Equipment (UE) Parameter Update (UPU) data, e.g., as specified by 3rd Generation Partnership Project (3GPP).

Regardless of the particular type of the device configuration data 14, the home network 10H in some embodiments transmits the device configuration data 14 to the wireless device 12 within a transparent container 18. The transparent container 18 is transparent in the sense that it is to be transparently forwarded to the wireless device 12 by the serving network 10S, e.g., forwarded to the wireless device 12 without modification and/or without inspection. For example, as shown, the transparent container 18 is to be transparently forwarded to the wireless device 12 by core network node 16S within the serving network 10S, e.g., implementing an Access and Mobility Function (AMF). In these and other embodiments, for instance, the device configuration data 14 is communicated from the home network 10H to the wireless device 12 via a Non-Access Stratum (NAS) transport procedure. In this case, the wireless device 12 may receive the device configuration data 14 via the serving network 10S, by receiving the transparent container 18 in a Payload container Information Element (IE) of a downlink NAS transport message.

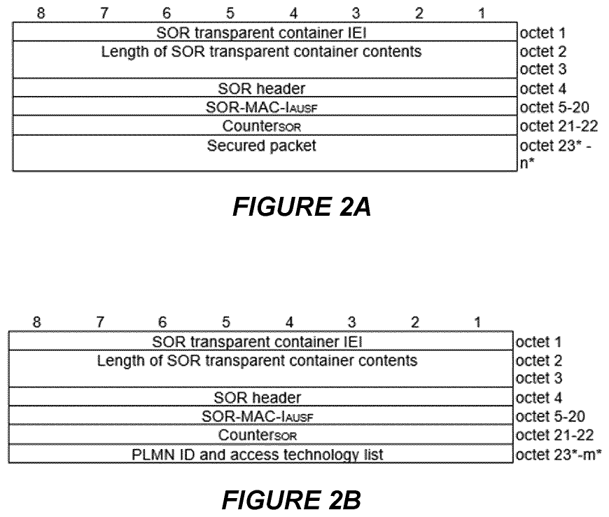

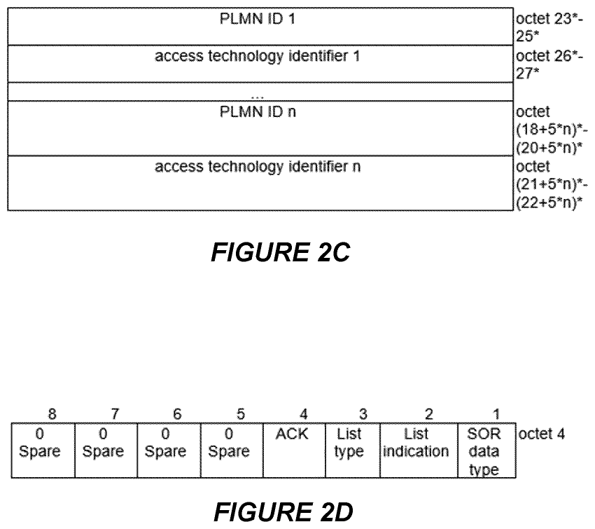

FIGS. 2A-2B show examples of the transparent container 18 in embodiments where the device configuration data 14 comprises SOR information. In this case, the transparent container 18 as shown may be referred to as an SOR transparent container information element (IE). FIG. 2A shows the SOR transparent container IE for list type with value “0” and SOR data type with value “0”, whereas FIG. 2B shows the SOR transparent container IE for list type with value “1” and SOR data type with value “0”. In both cases, the SOR transparent container IE includes the length of the SOR transparent container contents in octets 2 and 3, includes an SOR header in octet 4, includes an message authentication code (MAC) referred to as SOR-MAC-I_{AUSF} in octets 5-20, and includes a counter Counter_{SOR} in octets 21-22. In the remaining octets, the SOR transparent container IE in FIG. 2A includes a secured packet whereas the SOR transparent container IE in FIG. 2B includes a PLMN ID and access technology list. In either case, the transparent container 18 may be in a REGISTRATION ACCEPT message.

FIG. 2C shows the PLMN ID and access technology list in some embodiments. As shown, the PLMN ID and access technology identifier may be provided in decreasing order of priority, i.e. PLMN ID 1 indicates highest priority and PLMN ID n indicates lowest priority.

FIG. 2D shows the SOR header for SOR data type with value “0” in some embodiments. As shown, the SOR header includes an ACK field in bit 4, a list type field in bit 3, a list indication in bit 2, and an SOR data type field in bit 1.

In any event, the wireless device 12 is configured to acknowledge successful reception of the device configuration data 14, e.g., if requested to do so by a flag in the received transparent container 18, such as the ACK field in bit 4 of the SOR header shown in FIG. 2D. In some embodiments, successful reception means that the wireless device 12 has received the device configuration data 14 with its integrity intact. For example, the wireless device 12 may perform a security check of the device configuration data 14, e.g., including checking the integrity of the device configuration data 14. The wireless device 12 in this case may acknowledge successful reception of the device configuration data 14 by acknowledging a successful security check of the device configuration data 14.

As shown in FIG. 1, the wireless device 12 transmits a transparent container 20 that acknowledges successful reception of the device configuration data 14, e.g., by acknowledging a successful security check of the device configuration data 14. Similar to the transparent container 18 described above, the transparent container 20 may be transparent in the sense that it is to be transparently forwarded to the core network node 16H in the home network 10H by the serving network 10S, e.g., forwarded without modification and/or without inspection. For example, as shown, the transparent container 20 is to be transparently forwarded to the core network node 16H in the home network 10H by core network node 16S within the serving network 10S. In these and other embodiments, for instance, the transport container 20 is communicated to the home network 10H via a Non-Access Stratum (NAS) transport procedure. In this case, the wireless device 12 may transmit the transparent container 20 to the core network node 16H via the serving network 10S, by transmitting the transparent container 20 in a Payload container Information Element (IE) of an uplink NAS transport message. The wireless device 12 may for instance transmit, to the serving AMF, a Registration Complete message with the transparent container 20 included therein.

In some embodiments, the wireless device 12 only transmits the transparent container 20 if the wireless device 12 successfully received the device configuration data 14. That is, in this case, no transparent container 20 is transmitted if the wireless device 12 did not successfully receive the device configuration data 14. In this case, the transparent container 20 inherently or implicitly acknowledges successful reception of the device configuration data 14.

According to embodiments herein, the transparent container 20 not only acknowledges successful reception of the device configuration data 14 but also contains a set of one or more information fields 22, e.g., that convey information other than acknowledgment of successful reception of the device configuration data 14. For example, in embodiments where the device configuration data 14 includes steering of roaming information, the set of one or more information fields 22 may include an information field that indicates the wireless device 12 supports steering of roaming (SOR) connected mode control information (CMCI). Here, the SOR CMCI comprises information to control timing for the wireless device 14 to move from connected mode (e.g., radio resource control, RRC, connected mode) to idle mode (e.g., RRC idle mode) in order to perform steering of roaming. The information field in this case may be referred to as an “ME Support of SOR-CMCI” indicator field, e.g., with possible values of “supported” or “not supported”. As another example, in other embodiments where the device configuration data 14 includes a set of one or more device parameters, the set of one or more information fields 22 may include an information field indicating that, or whether, the wireless device 12 supports a certain device parameter from the home network 10H. For instance, where the device configuration data 14 includes user equipment (UE) Parameter Update (UPU) data, the set of one or more information fields 22 may include a field indicating that, or whether, the wireless device 12 supports a certain parameter for UPU.

Notably, the transparent container 20 herein furthermore contains integrity protection data 24, e.g., in the form of a message authentication code (MAC). This integrity protection data 24 integrity protects the set of information field(s) 22. In some embodiments, at least one of the information field(s) 22 in the set is configurable to have any of multiple possible values. For example, the set of information field(s) 22 may include an information field whose value is able to be set to any one of multiple different possible values allowed for that information field, i.e., the information field does not carry a constant value.

Regardless, embodiments herein advantageously guard against tampering with the set of information field(s) 22. Embodiments herein for example guard against the serving network 10S tampering with the set of information field(s) 22. Where the set of information field(s) 22 includes SOR information, for instance, it may be lucrative for the serving network 10S to tamper with the set of information field(s) 22 and keep the wireless device 12 within the serving network 10S rather than roam to a different network. Embodiments herein guard against such malicious tampering with the set of information field(s) 22. The integrity protection of the set of information field(s) 22 may be in addition to any integrity protection of the acknowledgement of successful reception of the device configuration data 14. These and other embodiments, then, advantageously enable the transparent container 20 to be exploited for conveying other information securely to the home network 10H besides just the acknowledgement of successful reception of the device configuration data 14.

In some embodiments, core network node 16H in the home network 10H receives the transparent container 20, e.g., via core network node 16S in the serving network 10S. The core network node 16H as shown may transmit the transparent container 20, or at least the set of information field(s) 22, to an authentication server 10A, e.g., implementing an Authentication Server Function (AUSF), in the home network 10H. The core network node 16H may do so, for instance, as part of a request for assistance in checking the integrity of the set of information field(s) 22. In these and other embodiments, then, the authentication server 10A correspondingly transmits integrity checking information 32 to the core network node 16H.

In one embodiment, this integrity checking information 32 indicates a result of a check by the authentication server 10A of the integrity of the set of one or more information fields 22. In this case, the authentication server 30 is the entity that actually checks the integrity of the set of information field(s) 22.

In another embodiment, by contrast, the integrity checking information 32 is usable by the core network node 16H to check the integrity of the set of one or more information fields 22. For example, in this case, the integrity checking information 32 may be expected integrity protection data, e.g., in the form of an expected MAC, that can be checked against the integrity protection data 24 in the transparent container 20 to determine whether the integrity of the set of information field(s) 22 is intact. Accordingly, the core network node 16H checks whether the expected integrity protection data corresponds to (e.g., matches or is equal to) the integrity protection data 24 contained in the transparent container 20.

In either case, note that in some embodiments, the authentication server 30 generates the integrity checking information 32 after the wireless device 12 has already transmitted the transparent container 20 and/or after the core network node 16H has received the transparent container 20, as opposed to the authentication server 30 having precomputed the integrity checking information in advance of such actions. This means that the integrity checking information 32 may advantageously account for inclusion of the set of information field(s) 22 in the transparent container 20.

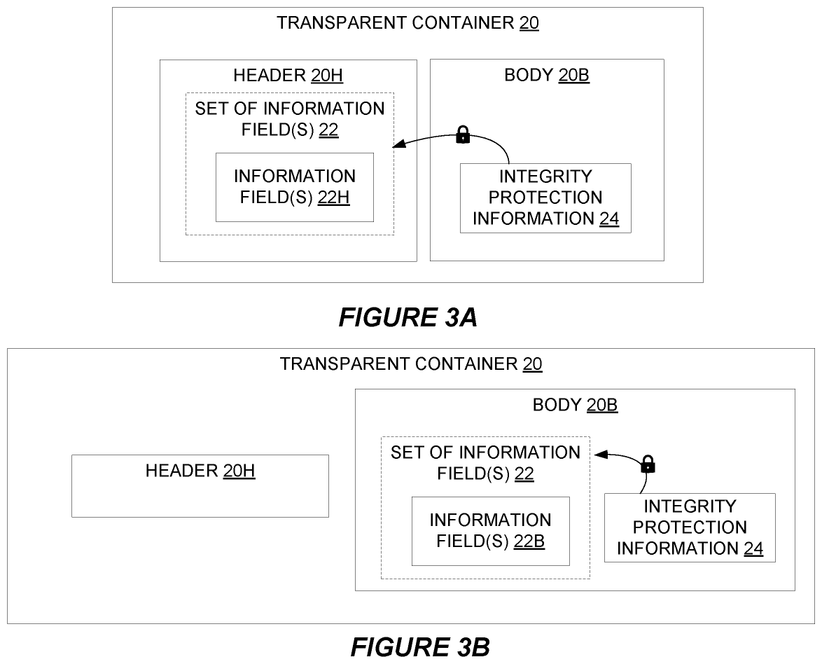

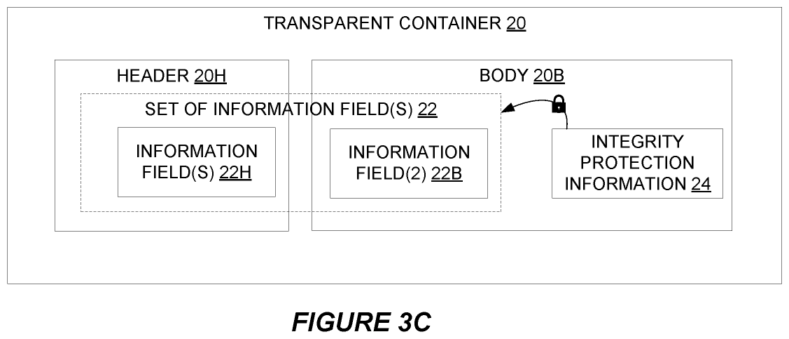

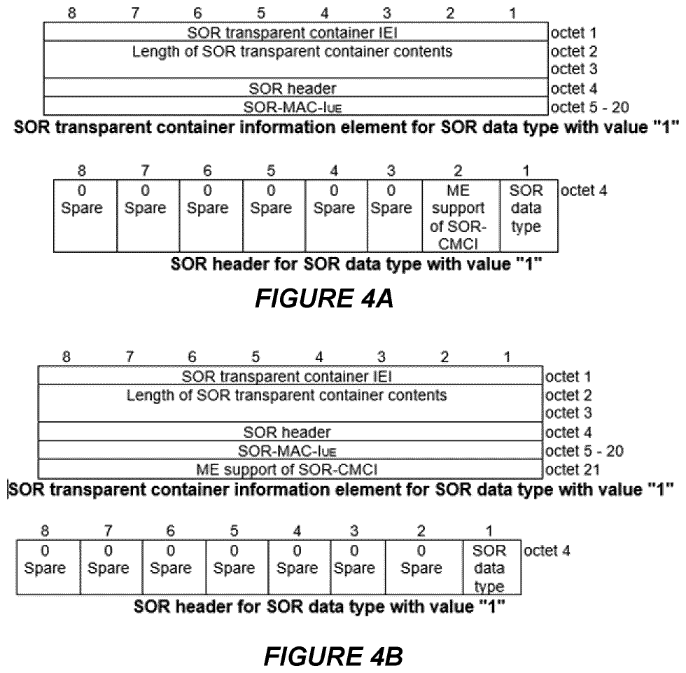

Note that the set of information field(s) 22 may be included in or span any part(s) of the transparent container 20. As shown in FIG. 3A, for example, the transparent container 20 contains a header 20H. The header 20H may be distinguished from a body 20B of the transparent container 20, e.g., where the integrity protection data 24 may be included in the body 20B as shown. The header 20H includes at least one information field 22H in the set of one or more information fields 22 integrity protected by the integrity protection data 24. In one embodiment, the integrity protection data 24 selectively integrity protects the at least one information field 22H in the set. In other embodiments, though, the integrity protection data 24 integrity protects the at least one information field 22H in the set by integrity protecting the header 20H as a whole. That is, the integrity protection data 24 in this case integrity protects the header 20H. FIG. 4A shows one example of the transparent container 20 where the device configuration data 14 includes SOR information. As shown in FIG. 4A, the integrity protection data 24 is the SoR-MAC-I_UE in octets 5-20 of the transparent container, where the SoR-MAC-I_UE integrity protects at least the ME support of SOR-CMCI field in bit/byte 2 of the SOR header, e.g., by integrity protecting the whole SOR header.

FIG. 3B shows another example where the transparent container 20 contains a header 20H and a body 20B, where the body 20B includes at least one information field 22B in the set of one or more information fields 22 integrity protected by the integrity protection data 24. For instance, the integrity protection data 24 may be included in the body 20B (e.g., in octets 5-20) and the information field(s) 22B may also be included in the body 20B after the integrity protection data 24 (e.g., after octet 20). FIG. 4B shows one example of the transparent container 20 where the device configuration data 14 includes SOR information. As shown in FIG. 4B, the integrity protection data 24 is the SoR-MAC-I_UE in octets 5-20 of the transparent container, where the SoR-MAC-I_UE integrity protects at least the ME support of SOR-CMCI field in octet 21 of the transparent container 20.

FIG. 3C shows yet another example that is a combination of FIGS. 3A and 3B. In FIG. 3C, the header 20H includes at least one information field 22H in the set of one or more information fields 22 integrity protected by the integrity protection data 24, and the body 20B includes at least one information field 22B in the set of one or more information fields 22 integrity protected by the integrity protection data 24. In one embodiment, the integrity protection data 24 selectively integrity protects the at least one information field 22H in the header 20H and the at least one information field 22B in the body 20B. In other embodiments, though, the integrity protection data 24 integrity protects the at least one information field 22H in the header 20H by integrity protecting the header 20H as a whole and integrity protects information fields, if any, placed after the integrity protection data 24 in the transparent container 20 (e.g., placed after the integrity protection data 24 in the transparent container's body. In this case, then, as shown, the set of information field(s) 22 spans across the transparent container's header 20H and body 20B.

In any event, in some embodiments, the wireless device 12 generates the integrity protection data 24 as follows. The wireless device 12 forms an input to a key derivation function (KDF) from a set of input parameters, where the set of input parameters includes at least the set of one or more information fields. The wireless device 12 calculates an output of the key derivation function with the formed input, and then generates the integrity protection data 24 from the output of the key derivation function. In one example, for instance, the set of input parameters includes:
an FC parameter equal to 0x78;
a P0 parameter equal to a P0 input value, wherein the P0 input value includes at least the set of one or more information fields 22;
an L0 parameter equal to a length of the P0 input value;
a P1 parameter equal to a counter; and
an L1 parameter equal to a length of the counter.

In some embodiments, the authentication server 30 generates the expected integrity protection data in a corresponding way.

Consider now examples of some embodiments herein where the device configuration data 14 comprises “Steering of Roaming” information or “UE parameters update” data, e.g., as examples in a context where a 5G core network may send information to the UE that is integrity protected between Home Network and Mobile Equipment (ME). The procedures for SOR and UPU also provide means for the UE to send an Acknowledgement that is integrity protected between ME and Home Network.

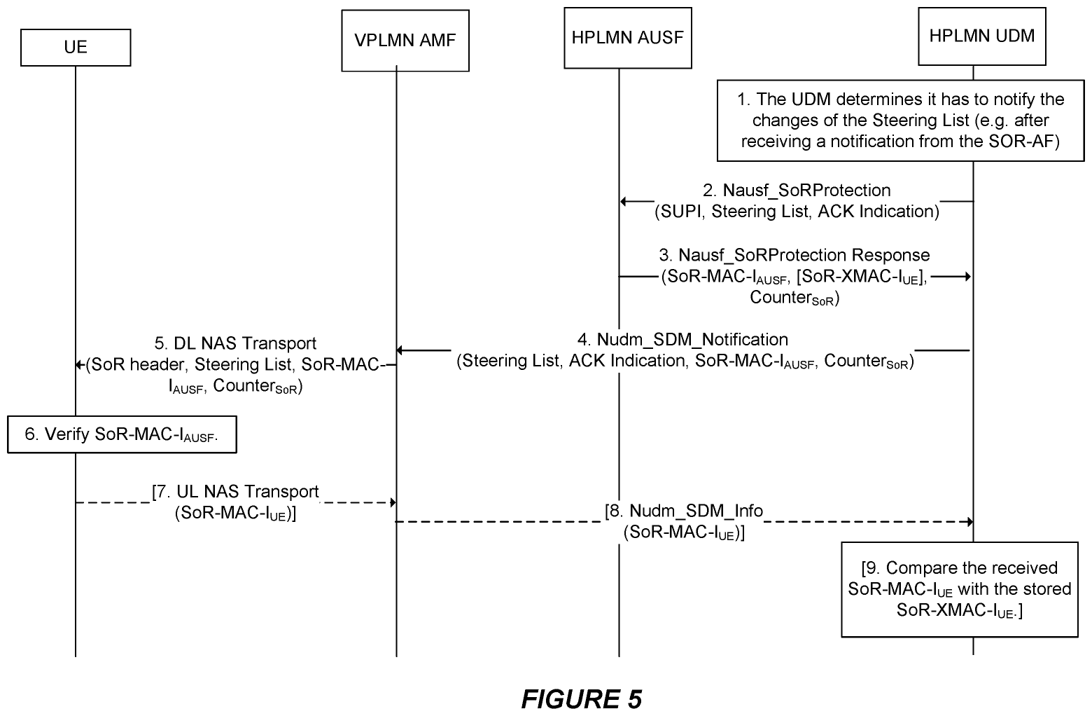

FIG. 5 shows the procedure heretofore for providing a list of preferred PLMN/access technology combinations after registration.

The AUSF in the HPLMN offers SoRProtection and UPUProtection services that generate a MAC (SoR-MAC-Iausf) used to integrity protect the SoR/UPU information provided by the UDM to the UE (steps 2-3 in FIG. 5).

In addition to the MAC for the protection of the information provided by the UDM to the UE, these AUSF services can optionally, if requested by the UDM, generate a MAC to protect the acknowledgment from the UE that the SoR/UPU information was received at the UE (refer to [SoR-XMAC-Iue] in step 3 of FIG. 5). The UDM can request the AUSF to generate the MAC for the UE response before the UDM has received the UE response, since the content of the UE response including the ACK of the reception of the SoR/UPU is known in advance by the AUSF/UDM:

From TS 33.501, Annex A.18:

When deriving a SoR-MAC-IUE from K_{AUSF}, the following parameters shall be used to form the input S to the Key Derivation Function (KDF).
FC=0x78,
P0=0x01 (SoR Acknowledgement: Verified the Steering of Roaming Information successfully),
L0=length of SoR Acknowledgement (i.e. 0x00 0x01),
P1=Counter_{SoR},
L1=length of Counter_{SoR}.

The input key KEY shall be K_{AUSF}.

The SoR-MAC-I_{UE} is identified with the 128 least significant bits of the output of the KDF.

Some embodiments herein address the challenge that, in 3GPP Rel-17, the UE may be able to indicate the “ME support of SOR-CMCI” in the SoR information acknowledgement (under certain requirements). That is, in 3GPP Rel-17, the UE may include additional information in the SoR information acknowledgment.

Additionally, in order to manage additional UE parameters in the UPU procedure in 3GPP Rel 17 and onwards, there may be a negotiation mechanism between the UDM and the UE in which the UE can include the UE params supported by the UE. Again, in 3GPP Rel-17, the UE may include additional information in the UPU information acknowledgment.

However as defined heretofore, the MAC to protect the SoR/UPU acknowledgement is precomputed by the AUSF and does not consider the possibility that the UE may include the “ME support of SOR-CMCI” indicator nor the list of UE params supported by the UE. Hence, if the UE includes any of this new information in the SoR/UPU acknowledgment, the precomputed MAC in the HPLMN will heretofore not be valid and the UDM cannot verify the integrity protection of the Acknowledgement.

Certain aspects of the present disclosure and their embodiments may provide solutions to these or other challenges. Some embodiments propose that the HPLMN AUSF offers new service operations for the protection of the SoR/UPU acknowledgement responses and that the UDM uses these new services to verify the integrity protection of SoR/UPU Acknowledgement responses in Rel-17.

Certain embodiments may provide one or more of the following technical advantage(s). UDM can verify the integrity protection of the SoR/UPU Acknowledgement.

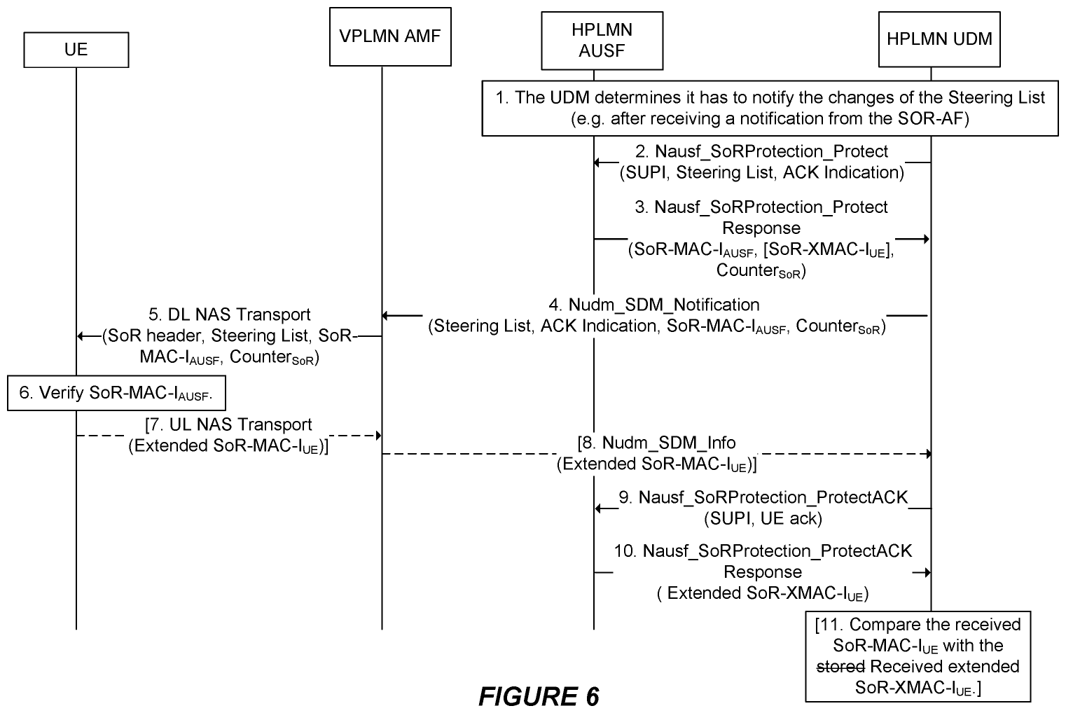

FIG. 6 shows a first embodiment for a mechanism to protect the SoR/UPU acknowledgement responses when the UE includes additional information in these responses in Rel-17. In this example, the extended SoR-MAC-I_UE represents an example of the integrity protection data 24. FIG. 6 shows the SoR case but the same can be applied to UPU procedure.

One way to implement the embodiment in FIG. 6 is to change the SoR procedure in clauses 6.14.2.1 and 6.14.2.2 and the UPU procedure in clause 6.15.2 of TS 33.501 v17.1.0 in the following way:

In step 7, the UE includes the extended SoR-MAC-I_UE/UPU-MAC-I_UE that integrity protects the new UE capabilities included in the ack message, where these new UE capabilities exemplify the set information field(s) 22 to be integrity protected. Potentially, the UE also includes the Counter_SoR/Counter_UPU, as another examiner of the set of information field(s) 22 to be integrity protected. Also, two new steps 9 and 10 are introduced after the UDM has received the UE acknowledgement in step 8. The UDM sends a request to the AUSF to verify the UE acknowledgment using a new service operation Nausf_SoR/UPUProtection_ProtectACK, which includes the SUbscription Permanent Identifier (SUPI) and received UE acknowledgement to the AUSF in Step 9, and potentially the Counter_SoR/Counter_UPU. The AUSF computes the extended SoR-XMAC-I_UE/UPU-XMAC-I_UE and provides it, potentially with the Counter_SoR/Counter_UPU to the UDM in step 10. In step 11, the UDM checks the integrity of the UE capabilities included in the ack message by comparing the extended SoR-XMAC-I_UE/UPU-XMAC-I_UE with the extended SoR-MAC-I_UE/UPU-MAC-I_UE sent by the UE.

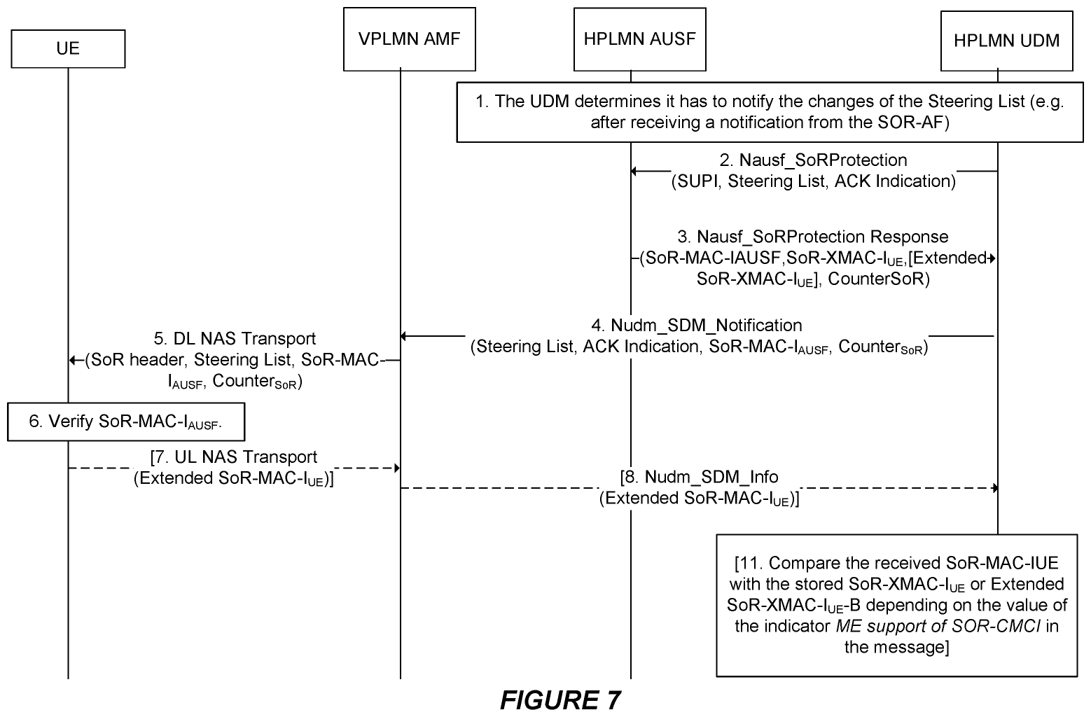

FIG. 7 shows a second embodiment in which the AUSF sends two XMAC values depending on the UE Ack message. In this example, the extended SoR-MAC-I_UE represents an example of the integrity protection data 24. This embodiment is described for the SoR case, but holds for the UPU case as well.

One way to implement the embodiment in FIG. 7 is to change the SoR procedure in clauses 6.14.2.1 and 6.14.2.2 and the UPU procedure in clause 6.15.2 of TS 33.501 v17.1.0 in the following way:

In Step 2, the AUSF calculates two SoR-XMAC-IUE values; one for the case that the ME support of SOR-CMCI indicator is not included (SoR-XMAC-IUE) as in the legacy specification, and one for the case that the indicator is included (extended SoR-XMAC-IUE). The AUSF sends both XMAC values to the UDM.

In Step 11, when the UDM receives the UE acknowledgement, based on the UE acknowledgement message contents, it verifies whether the message SoR-MAC-IUE matches the SoR-XMAC-I_{UE} or extended SoR-XMAC-IUE. In other words, if the UE acknowledgement includes the ME support of SOR-CMCI indicator, the extended SoR-MAC-IUE is compared with extended SoR-XMAC-I_{UE}. If the UE acknowledgement does not include the ME support of SOR-CMCI indicator, the received SoR-MAC-IUE is compared with SoR-XMAC-IUE. Depending on the result of the comparison the UE acknowledgement message is accepted or rejected.

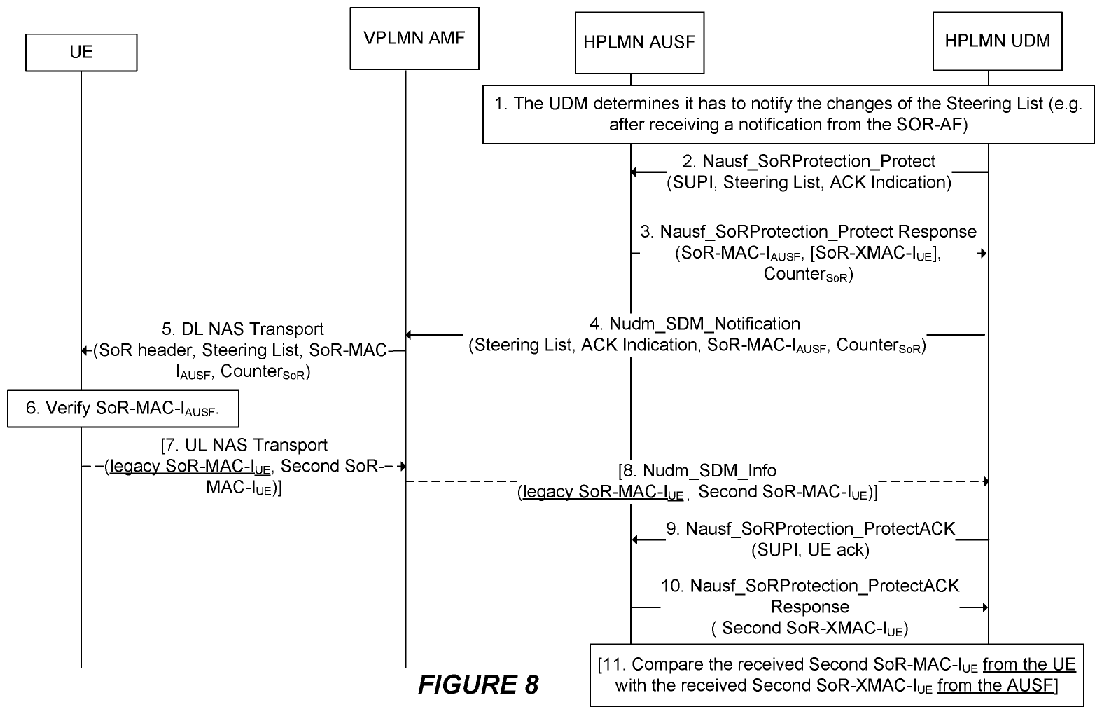

FIG. 8 shows a third embodiment for a mechanism to protect the SoR/UPU acknowledgement responses when the UE includes additional information in these responses in Rel-17. In this example, the second SoR-MAC-I_UE represents an example of the integrity protection data 24. FIG. 8 shows the SoR case but the same can be applied to UPU procedure.

One way to implement the embodiment in FIG. 8 is to change the SoR procedure in clauses 6.14.2.1 and 6.14.2.2 and the UPU procedure in clause 6.15.2 of TS 33.501 v17.1.0 in the following way:

In step 7, the UE includes the legacy SoR-MAC-I_UE that integrity protects the acknowledgment from the UE as described in Rel-15/Rel-16 in case the network is a legacy network. The UE calculates a new second MAC. This new second MAC is named SECOND_SoR-MAC-I_UE/SECOND_UPU-MAC-I_UE as this new second MAC is not intended to replace or extend the legacy SoR-MAC-I.

In step 7, the UE includes the legacy SoR-MAC-I_UE that integrity protects the acknowledgment from the UE as described in Rel-15/Rel-16 and the new SECOND SoR-MAC-I_UE/SECOND UPU-MAC-I_UE that integrity protects the new UE capabilities and the legacy SoR-MAC-I_UE included in the ack message. Potentially, the UE also includes the Counter_SoR/Counter_UPU. Also, two new steps 9 and 10 are introduced after the UDM has received the UE acknowledgement in step 8. The UDM sends a request to the AUSF to verify the UE acknowledgment using a new service operation Nausf_SoR/UPUProtection_ProtectACK, which includes the SUPI and received UE acknowledgement to the AUSF in Step 9, and potentially the Counter_SoR/Counter_UPU. The AUSF computes the SECOND SoR-XMAC-I_UE/SECOND UPU-XMAC-I_UE and provides it, potentially with the Counter_SoR/Counter_UPU, to the UDM in step 10. In step 11, the UDM compares the SECOND SoR-XMAC-I_UE/SECOND UPU-XMAC-I_UE received from the AUSF with the SECOND SoR-MAC-I_UE/SECOND UPU-MAC-I_UE sent by the UE.

The UE needs to include the legacy SoR-MAC-I_UE in case the network is a legacy network.

In another embodiment and for future proofness, the new AUSF service depicted in steps 9 and 10 covers all the header information. In Step 9, the UDM proceeds as follows:
1. If the received SoR-MAC-IUE matches the SOR-XMAC-IUE, then this is a legacy UE that does not support the extended protection. The UDM concludes that the UE has received the Steering List as expected.
2. Else the UDM queries the AUSF for the extended SoR-XMAC-IUE in step 9 and passes the header and if needed the Steering List to the AUSF. The AUSF computes the extended SoR-XMAC-IUE based on the received information and responds to the UDM. If the received SoR-MAC-IUE matches the extended SOR-XMAC-IUE, then this a new UE that does support the extended protection. Observe that this step is performed regardless of the header values. The UDM concludes that the UE has received the Steering List as expected and that the UE supports the extended protection. The UDM can safely process the information included in the header.
3. Else, the UDM concludes that the SoR procedure has failed.

In another embodiment for the new AUSF service, the UDM queries the UDM to verify the received SoR-XMAC-IUE by passing in addition the received MAC to the AUSF in step 9. The AUSF then computes the extended SoR-XMAC-IUE based on the received information and compares it with the received MAC from the UDM. The AUSF then responds to the UDM by indicating whether the value matches or not in step 10. Based on the AUSF reply, the UDM proceeds as described in the previous UDM.

As these examples illustrate, then, some embodiments herein address an issue in integrity protection of Steering of Roaming (SOR) header and other fields of SOR transparent container carrying SOR acknowledgement.

Consistent with 3GPP TS 23.122 v17.2.0, the UE in some embodiments includes the “ME support of SOR-CMCI” indicator as follows. If the UDM has requested an acknowledgement from the UE and the UE verified that the steering of roaming information has been provided by the HPLMN, then the UE sends the REGISTRATION COMPLETE message to the serving AMF with an SOR transparent container including the UE acknowledgement. And the UE sets the “ME support of SOR-CMCI” indicator in the header of the SOR transparent container to “supported”.

In these embodiments, then, the “ME support of SOR-CMCI” indicator is in the SOR header of the SOR transparent container carrying the UE acknowledgement.

According to TS 33.501 v17.1.0, SOR-MAC-Iue included in the SOR transparent container carrying the SOR acknowledgement is heretofore generated as follows. When deriving a SoR-MAC-IUE from KAUSF, the following parameters shall be used to form the input S to the KDF.
FC=0x78,
P0=0x01 (SoR Acknowledgement: Verified the Steering of Roaming Information successfully),
L0=length of SoR Acknowledgement (i.e. 0x00 0x01),
P1=CounterSoR,
L1=length of CounterSoR.

The input key KEY shall be KAUSF.

The SoR-MAC-IUE is identified with the 128 least significant bits of the output of the KDF.

Thus, SOR-MAC-Iue heretofore does not ensure that the Visited Public Land Mobile Network (VPLMN) does not modify the SOR header of the SOR transparent container carrying the SOR acknowledgement and does not remove the “ME support of SOR-CMCI” indicator. That is, the SOR header of the SOR transparent container carrying the SOR acknowledgement is NOT integrity protected between the UE and the HPLMN.

If the VPLMN removes the “ME support of SOR-CMCI” indicator from the SOR header of the SOR transparent container carrying the SOR acknowledgement, the HPLMN will heretofore not be able to send the SOR-CMCI to the UE and thus the UE will release the Non-Access Stratum Signaling (NAS) signalling connection based on UE implementation (rather than based on the HPLMN provided SOR-CMCI). Depending on UE implementation, this would enable the VPLMN to keep the UE in the VPLMN longer than wished by the HPLMN. That is, removing the “ME support of SOR-CMCI” indicator from the SOR header of the SOR transparent container carrying the SOR acknowledgement would be advantageous for the VPLMN.

In order to ensure that the VPLMN does not remove the “ME support of SOR-CMCI” indicator from the SOR header of the SOR transparent container carrying the SOR acknowledgement, the SOR header of the SOR transparent container carrying the SOR acknowledgement in some embodiments herein is be integrity protected between the UE and the HPLMN.

Furthermore, to avoid similar issues with additional indications in future fields of the SOR transparent container carrying the SOR acknowledgement, any fields placed after the SOR-MAC-Iue in the SOR transparent container carrying the SOR acknowledgement may also be integrity protected between the UE and the HPLMN.

The above needs to be conditional to the HPLMN being complaint to Rel-17 as Rel-15 or Rel-16 HPLMN would not change. Furthermore, Rel-17 HPLMN also needs to be ready to receive SOR-MAC-Iue calculated as in Rel-15 from Rel-15 or Rel-16 UEs.

In one embodiment to address this, Rel-17 HPLMN indicates in the SOR header of the SOR transparent container sent to the UE, that the UE is to calculate the SOR-MAC-Iue with additional fields.

In another embodiment, if the SOR header of a received SOR transparent container indicates that the UE is to calculate the SOR-MAC-Iue with additional fields, the Rel-17 UE calculates the SOR-MAC-Iue additionally with: (i) the SOR header of the SOR transparent container carrying the SOR acknowledgement; and (ii) any fields placed after the SOR-MAC-Iue in the SOR transparent container carrying the SOR acknowledgement. The UE also indicates in the SOR header of the SOR transparent container carrying the SOR acknowledgement that the UE calculated the SOR-MAC-Iue with additional fields.

In yet another embodiment, if Rel-17 HPLMN indicated in the SOR header of the SOR transparent container sent to the UE, that the UE is to calculate the SOR-MAC-Iue with additional fields, and if the SOR header of the SOR transparent container carrying the SOR acknowledgement indicates that the UE calculated the SOR-MAC-Iue with additional fields, then Rel-17 HPLMN calculates the SoR-XMAC-Iue additionally with (i) the SOR header of the SOR transparent container carrying the SOR acknowledgement; and (ii) any fields placed after the SOR-MAC-Iue in the SOR transparent container carrying the SOR acknowledgement.

According to some embodiments, then, the SOR header of the SOR transparent container carries the SOR acknowledgement and fields, if any, placed after the SOR-MAC-Iue in the SOR transparent container carrying the SOR acknowledgement are integrity protected between Rel-17 UE and Rel-17 HPLMN.

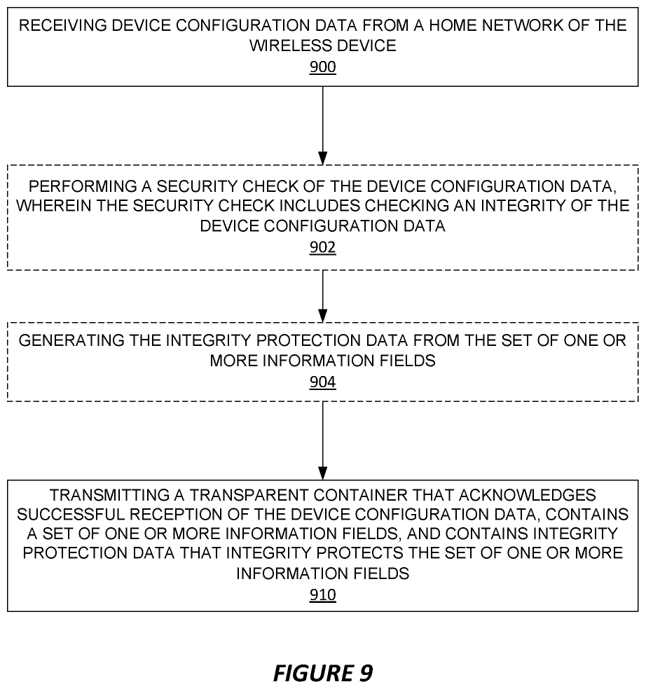

In view of the modifications and variations herein, FIG. 9 depicts a method performed by a wireless device 12 in accordance with particular embodiments. The method includes receiving device configuration data 14 from a home network 10H of the wireless device 12 (Block 900). The method further comprises transmitting a transparent container 20 that acknowledges successful reception of the device configuration data 14, contains a set of one or more information fields 22, and contains integrity protection data 24 that integrity protects the set of one or more information fields 22 (Block 910).

In some embodiments, the transparent container 20 contains a header 20H. In some embodiments, the header 20H includes at least one information field 22H in the set of one or more information fields 22 integrity protected by the integrity protection data 24. In one or more of these embodiments, the integrity protection data 24 integrity protects the header 20H.

In some embodiments, the transparent container 20 contains a header 20H and a body 20B. In some embodiments, the body 20B includes at least one information field 22B in the set of one or more information fields 22 integrity protected by the integrity protection data 24.

In some embodiments, the transparent container 20 contains a header 20H and a body 20B. In some embodiments, the header 20H includes at least one information field 22H in the set of one or more information fields 22 integrity protected by the integrity protection data 24, and the body 20B includes at least one information field 22B in the set of one or more information fields 22 integrity protected by the integrity protection data 24. In one or more of these embodiments, the body 20B includes the integrity protection data 24, and the integrity protection data 24 integrity protects the header 20H and integrity protects all of the body 20B except the integrity protection data 24.

In some embodiments, the integrity protection data 24 integrity protects the whole transparent container 20 except for the integrity protection data 24.

In some embodiments, the method further comprises generating the transparent container 20 to be included in the uplink control plane message by generating an intermediate transparent container that contains the set of one or more information fields 22. The method further comprises generating the transparent container 20 to be included in the uplink control plane message by generating the integrity protection data 24 to integrity protect the intermediate transparent container that contains the set of one or more information fields 22. The method further comprises generating the transparent container 20 to be included in the uplink control plane message by adding the integrity protection data 24 to the intermediate transparent container to form the transparent container 20 to be included in the uplink control plane message.

In some embodiments, the device configuration data 14 includes steering of roaming information. In some embodiments, the steering of roaming information comprises information for encouraging the wireless device 12 to roam to a preferred roamed-to-network indicated by the home network 10H.

In some embodiments, the set of one or more information fields 22 includes an information field that indicates the wireless device 12 supports steering of roaming connected mode control information. In some embodiments, the steering of roaming connected mode control information comprises information to control timing for the wireless device 12 to move from connected mode to idle mode in order to perform steering of roaming.

In some embodiments, the integrity protection data 24 comprises SoR-MAC-I_{UE}.

In some embodiments, the device configuration data 14 includes a set of one or more device parameters. In one or more of these embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields 22 includes an information field indicating that, or whether, the wireless device 12 supports a certain device parameter from the home network 10H.

In some embodiments, the device configuration data 14 includes User Equipment, UE, Parameter Update, UPU, data.

In some embodiments, the set of one or more information fields 22 includes a field indicating that, or whether, the wireless device 12 supports a certain parameter for UPU.

In some embodiments, the integrity protection data 24 comprises UPU-MAC-I_{UE}.

In some embodiments, the integrity protection data 24 comprises a message authentication code, MAC.

In some embodiments, the method further comprises generating the integrity protection data 24 from the set of one or more information fields 22 (Block 904). In one or more of these embodiments, generating the integrity protection data 24 comprises forming an input to a key derivation function from a set of input parameters. In some embodiments, the set of input parameters includes at least the set of one or more information fields 22. Generating the integrity protection data 24 also comprises calculating an output of the key derivation function with the formed input. Generating the integrity protection data 24 also comprises generating the integrity protection data 24 from the output of the key derivation function. In one or more of these embodiments, the transparent container 20 contains a header 20H. In some embodiments, the header 20H includes at least one information field 22H in the set of one or more information fields 22 integrity protected by the integrity protection data 24, and the set of input parameters includes the header 20H. In one or more of these embodiments, the transparent container 20 contains a header 20H and a body 20B. In some embodiments, the body 20B includes at least one information field 22B in the set of one or more information fields 22 integrity protected by the integrity protection data 24, and the set of input parameters includes the body 20B except for the integrity protection data 24. In one or more of these embodiments, the set of input parameters includes the whole transparent container 20 except for the integrity protection data 24. In one or more of these embodiments, the set of input parameters includes an FC parameter equal to 0x78. The set of input parameters also includes a P0 parameter equal to a P0 input value. In some embodiments, the P0 input value includes at least the set of one or more information fields 22. The set of input parameters also includes an L0 parameter equal to a length of the P0 input value. The set of input parameters also includes a P1 parameter equal to a counter. The set of input parameters also includes an L1 parameter equal to a length of the counter.

In some embodiments, the method further comprises performing a security check of the device configuration data 14 (Block 902). In some embodiments, the security check includes checking an integrity of the device configuration data 14, and the transparent container 18 acknowledges successful reception of the device configuration data 14 by acknowledging a successful security check of the device configuration data 14.

In some embodiments, said receiving comprises receiving, from a first core network node 16S in a serving network 10S of the wireless device 12, a downlink control plane message that includes the device configuration data 14. In some embodiments, said transmitting comprises transmitting, to the first core network node 16S, an uplink control plane message that includes the transparent container 20. In some embodiments, the transparent container 20 is to be forwarded to a second core network node 16H in the home network 10H. In one or more of these embodiments, the downlink control plane message is a downlink non-access stratum transport message. In some embodiments, the uplink control plane message is an uplink non-access stratum transport message. In one or more of these embodiments, the first core network node 16S implements an access and mobility function, AMF. In one or more of these embodiments, the second core network node 16H implements a unified data management, UDM, function.

In some embodiments, said receiving comprises receiving the device configuration data 14 from a core network node 16H in the home network 10H. In some embodiments, said transmitting comprises transmitting the transparent container 20 towards the core network node 16H in the home network 10H.

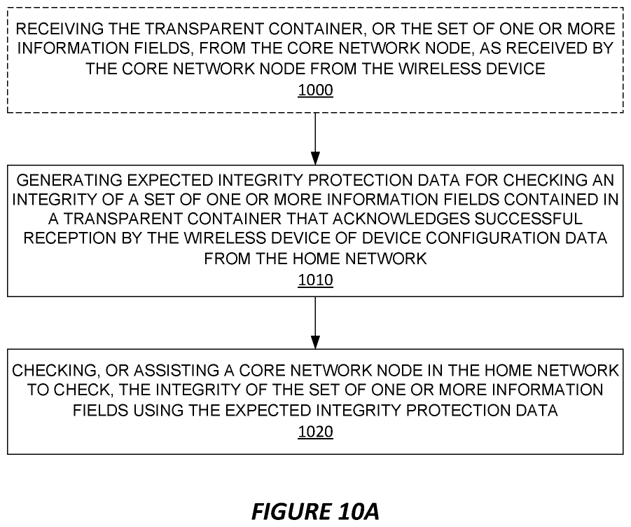

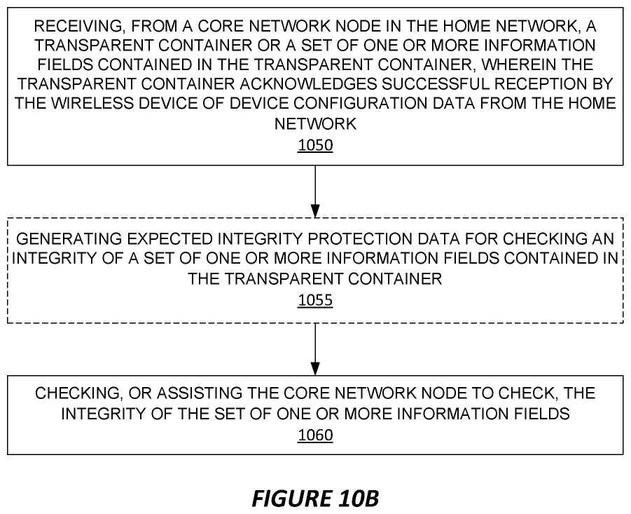

FIG. 10A depicts a method performed by an authentication server 10A configured for use in a home network 10H of a wireless device 12 in accordance with other particular embodiments. The method includes generating expected integrity protection data for checking an integrity of a set of one or more information fields 22 contained in a transparent container 20 that acknowledges successful reception by the wireless device 12 of device configuration data 14 from the home network 10H (Block 1010). The method also comprises checking, or assisting a core network node 16H in the home network 10H to check the integrity of the set of one or more information fields 22 using the expected integrity protection data (Block 1020).

In some embodiments, the transparent container 20 contains a header 20H. In some embodiments, the header 20H includes at least one information field 22H in the set of one or more information fields 22, and said generating comprises generating the expected integrity protection data from the at least one information field 22H. In one or more of these embodiments, said generating comprises generating the expected integrity protection data from the header 20H.

In some embodiments, the transparent container 20 contains a header 20H and a body 20B. In some embodiments, the body 20B includes at least one information field 22B in the set of one or more information fields 22, and said generating comprises generating the expected integrity protection data from the at least one information field 22B.

In some embodiments, the transparent container 20 contains a header 20H and a body 20B. In some embodiments, the header 20H includes at least one information field 22H in the set of one or more information fields 22. In some embodiments, the body 20B includes at least one information field 22B in the set of one or more information fields 22, and said generating comprises generating the expected integrity protection data from the at least one information field 22H included in the header 20H and from the at least one information field 22B included in the body 20B. In one or more of these embodiments, the body 20B includes the integrity protection data 24. In some embodiments, said generating comprises generating the expected integrity protection data from all of the body 20B except the integrity protection data 24.

In some embodiments, said generating comprises generating the expected integrity protection data from the whole transparent container 20 except for the integrity protection data 24.

In some embodiments, the device configuration data 14 includes steering of roaming information. In some embodiments, the steering of roaming information comprises information for encouraging the wireless device 12 to roam to a preferred roamed-to-network indicated by the home network 10H.

In some embodiments, the set of one or more information fields 22 includes an information field that indicates the wireless device 12 supports steering of roaming connected mode control information. In some embodiments, the steering of roaming connected mode control information comprises information to control timing for the wireless device 12 to move from connected mode to idle mode in order to perform steering of roaming.

In some embodiments, the expected integrity protection data comprises SoR-XMAC-I_{UE}.

In some embodiments, the device configuration data 14 includes a set of one or more device parameters. In one or more of these embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields 22 includes an information field indicating that, or whether, the wireless device 12 supports a certain device parameter from the home network 10H.

In some embodiments, the device configuration data 14 includes User Equipment, UE, Parameter Update, UPU, data.

In some embodiments, the set of one or more information fields 22 includes a field indicating that, or whether, the wireless device 12 supports a certain parameter for UPU.

In some embodiments, the expected integrity protection data comprises UPU-XMAC-I_{UE}.

In some embodiments, the expected integrity protection data comprises an expected message authentication code, XMAC.

In some embodiments, said generating comprises generating the expected integrity protection data from the set of one or more information fields 22. In one or more of these embodiments, generating the expected integrity protection data comprises forming an input to a key derivation function from a set of input parameters. In some embodiments, the set of input parameters includes at least the set of one or more information fields 22. Generating the expected integrity protection data also comprises calculating an output of the key derivation function with the formed input. Generating the expected integrity protection data also comprises generating the expected integrity protection data from the output of the key derivation function. In one or more of these embodiments, the transparent container 20 contains a header 20H. In some embodiments, the header 20H includes at least one information field 22H in the set of one or more information fields 22, and the set of input parameters includes the header 20H. In one or more of these embodiments, the transparent container 20 contains a header 20H and a body 20B. In some embodiments, the body 20B includes at least one information field 22B in the set of one or more information fields 22, and the set of input parameters includes the body 20B except for the integrity protection data 24. In one or more of these embodiments, the set of input parameters includes the whole transparent container 20 except for the integrity protection data 24. In one or more of these embodiments, the set of input parameters includes an FC parameter equal to 0x78. The set of input parameters also includes a P0 parameter equal to a P0 input value. In some embodiments, the P0 input value includes at least the set of one or more information fields 22. The set of input parameters also includes an L0 parameter equal to a length of the P0 input value. The set of input parameters also includes a P1 parameter equal to a counter. The set of input parameters also includes an L1 parameter equal to a length of the counter.

In some embodiments, the transparent container 18 acknowledges successful reception of the device configuration data 14 by acknowledging a successful security check of the device configuration data 14.

In some embodiments, the downlink control plane message is a downlink non-access stratum transport message. In some embodiments, the uplink control plane message is an uplink non-access stratum transport message.

In some embodiments, the method further comprises receiving the transparent container 20, or the set of one or more information fields 22, from the core network node 16H, as received by the core network node 16H from the wireless device 12 (Block 1000). In one or more of these embodiments, said generating comprises generating the expected integrity protection data from the transparent container 20, or the set of one or more information fields 22, received from the core network node 16H.

In some embodiments, said generating comprises generating the expected integrity protection data after the home network 10H receives the transparent container 20 from the wireless device 12.

In some embodiments, said generating comprises, before the home network 10H receives the transparent container 20 from the wireless device 12, generating the expected integrity protection data from an expected transparent container, or an expected set of one or more information fields 22, that is expected to be received by the home network 10H from the wireless device 12.

In some embodiments, said checking, or assisting a core network node 16H in the home network 10H to check, the integrity of the set of one or more information fields 22 comprises checking the integrity of the set of one or more information fields 22. In some embodiments, the method further comprises transmitting, to the core network node 16H in the home network 10H, information indicating a result of said checking.

In some embodiments, said checking, or assisting a core network node 16H in the home network 10H to check, the integrity of the set of one or more information fields 22 comprises assisting the core network node 16H to check the integrity of the set of one or more information fields 22. In some embodiments, said assisting comprises transmitting the expected integrity protection data to the core network node 16H.

In some embodiments, the core network node 16H implements a unified data management, UDM, function.

FIG. 10B depicts a different method performed by an authentication server 10A configured for use in a home network 10H of a wireless device 12 in accordance with yet other particular embodiments. The method may be implemented by the authentication server 10A separately from or in combination with the method in FIG. 10A. The method includes receiving, from a core network node 16H in the home network 10H, a transparent container 20 or a set of one or more information fields 22 contained in the transparent container 20 (Block 1050). The transparent container 20 acknowledges successful reception by the wireless device 12 of device configuration data 14 from the home network 10H. The method further comprises checking, or assisting the core network node 16H to check, the integrity of the set of one or more information fields 22 (Block 1060).

In some embodiments, the method further comprises generating expected integrity protection data for checking an integrity of a set of one or more information fields 22 contained in the transparent container 20 (Block 1055).

In some embodiments, the transparent container 20 contains a header 20H. In some embodiments, the header 20H includes at least one information field 22H in the set of one or more information fields 22, and said generating comprises generating the expected integrity protection data from the at least one information field 22H. In one or more of these embodiments, said generating comprises generating the expected integrity protection data from the header 20H.

In some embodiments, the transparent container 20 contains a header 20H and a body 20B. In some embodiments, the body 20B includes at least one information field 22B in the set of one or more information fields 22, and said generating comprises generating the expected integrity protection data from the at least one information field 22B.

In some embodiments, the transparent container 20 contains a header 20H and a body 20B. In some embodiments, the header 20H includes at least one information field 22H in the set of one or more information fields 22. In some embodiments, the body 20B includes at least one information field 22B in the set of one or more information fields 22, and said generating comprises generating the expected integrity protection data from the at least one information field 22H included in the header 20H and from the at least one information field 22B included in the body 20B. In one or more of these embodiments, the body 20B includes the integrity protection data 24. In some embodiments, said generating comprises generating the expected integrity protection data from all of the body 20B except the integrity protection data 24.

In some embodiments, said generating comprises generating the expected integrity protection data from the whole transparent container 20 except for the integrity protection data 24.

In some embodiments, the device configuration data 14 includes steering of roaming information. In some embodiments, the steering of roaming information comprises information for encouraging the wireless device 12 to roam to a preferred roamed-to-network indicated by the home network 10H.

In some embodiments, the set of one or more information fields 22 includes an information field that indicates the wireless device 12 supports steering of roaming connected mode control information. In some embodiments, the steering of roaming connected mode control information comprises information to control timing for the wireless device 12 to move from connected mode to idle mode in order to perform steering of roaming.

In some embodiments, the expected integrity protection data comprises SoR-XMAC-I_{UE}.

In some embodiments, the device configuration data 14 includes a set of one or more device parameters. In one or more of these embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields 22 includes an information field indicating that, or whether, the wireless device 12 supports a certain device parameter from the home network 10H.

In some embodiments, the device configuration data 14 includes User Equipment, UE, Parameter Update, UPU, data.

In some embodiments, the set of one or more information fields 22 includes a field indicating that, or whether, the wireless device 12 supports a certain parameter for UPU.

In some embodiments, the expected integrity protection data comprises UPU-XMAC-I_{UE}.

In some embodiments, the expected integrity protection data comprises an expected message authentication code, XMAC.

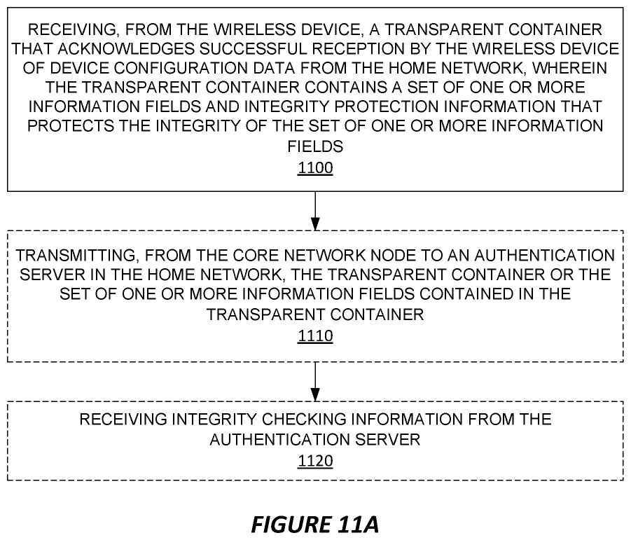

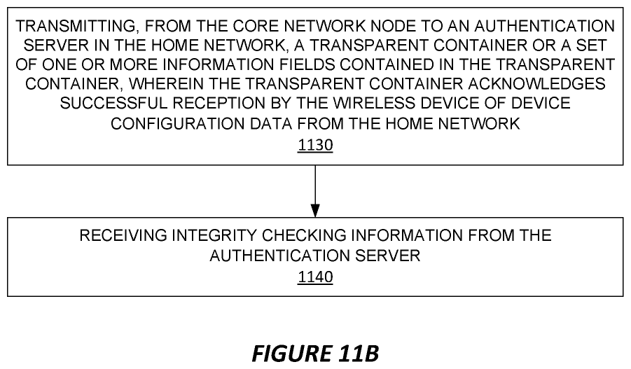

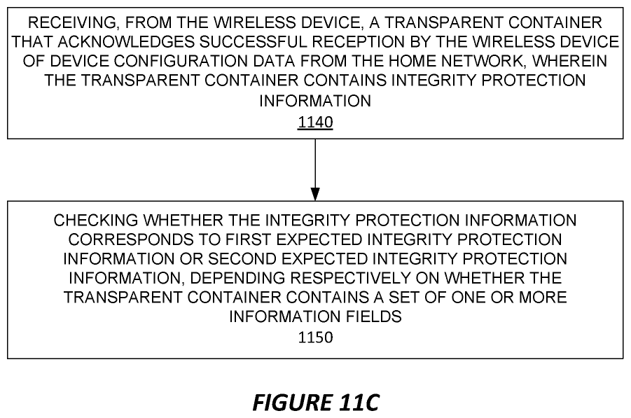

FIG. 11A depicts a method performed by a core network node 16H configured for use in a home network 10H of a wireless device 12 in accordance with other particular embodiments. The method comprises receiving, from the wireless device 12, a transparent container 20 that acknowledges successful reception by the wireless device 12 of device configuration data 14 from the home network 10H, wherein the transparent container 20 contains a set of one or more information fields 22 and integrity protection data 24 that protects the integrity of the set of one or more information fields 22 (Block 1100).

In some embodiments, the method also comprises transmitting, from the core network node 16H to an authentication server 10A in the home network 10H, the transparent container 20 or the set of one or more information fields 22 contained in the transparent container 20 (Block 1110). The method may further comprise receiving integrity checking information 32 from the authentication server 10A (Block 1120). For example, the integrity checking information 32 may either: (i) indicate a result of a check by the authentication server 10A of the integrity of the set of one or more information fields 22; or (ii) be usable by the core network node 16H to check the integrity of the set of one or more information fields 22.

In one or more of these embodiments, the integrity checking information 32 indicates the result of a check by the authentication server 10A of the integrity of the set of one or more information fields 22. In one or more of these embodiments, the integrity checking information 32 is usable by the core network node 16H to check the integrity of the set of one or more information fields 22. In one or more of these embodiments, the method further comprises using the integrity checking information 32 to check the integrity of the set of one or more information fields 22. In one or more of these embodiments, the integrity checking information 32 comprises expected integrity protection data. In some embodiments, said using comprises checking whether the expected integrity protection data corresponds to the integrity protection data 24 contained in the transparent container 20.

In some embodiments, the core network node 16H implements a unified data management, UDM, function.

In some embodiments, the transparent container 20 contains a header 20H. In some embodiments, the header 20H includes at least one information field 22H in the set of one or more information fields 22, and the integrity protection data 24 protects the integrity of the set of one or more information fields 22 by integrity protecting the header 20H.

In some embodiments, the transparent container 20 contains a header 20H and a body 20B. In some embodiments, the body 20B includes at least one information field 22B in the set of one or more information fields 22, and the integrity protection data 24 protects the integrity of the set of one or more information fields 22 by integrity protecting the at least one information field 22B in the body 20B.

In some embodiments, the transparent container 20 contains a header 20H and a body 20B. In some embodiments, the header 20H includes at least one information field 22H in the set of one or more information fields 22, and the body 20B includes at least one information field 22B in the set of one or more information fields 22, and the integrity protection data 24 protects the integrity of the set of one or more information fields 22 by integrity protecting the at least one information field 22H included in the header 20H and the at least one information field 22B included in the body 20B.

In some embodiments, the device configuration data 14 includes steering of roaming information. In some embodiments, the steering of roaming information comprises information for encouraging the wireless device 12 to roam to a preferred roamed-to-network indicated by the home network 10H.

In some embodiments, the set of one or more information fields 22 includes an information field that indicates the wireless device 12 supports steering of roaming connected mode control information. In some embodiments, the steering of roaming connected mode control information comprises information to control timing for the wireless device 12 to move from connected mode to idle mode in order to perform steering of roaming.

In some embodiments, the device configuration data 14 includes a set of one or more device parameters. In one or more of these embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields 22 includes an information field indicating that, or whether, the wireless device 12 supports a certain device parameter from the home network 10H.

In some embodiments, the device configuration data 14 includes User Equipment, UE, Parameter Update, UPU, data.

In some embodiments, the set of one or more information fields 22 includes a field indicating that, or whether, the wireless device 12 supports a certain parameter for UPU. In some embodiments, the transparent container 20 acknowledges successful reception of the device configuration data 14 by acknowledging a successful security check of the device configuration data 14.

FIG. 11B depicts another method performed by a core network node 16H configured for use in a home network 10H of a wireless device 12 in accordance with yet other particular embodiments. The method may be implemented by the core network node 16H separately from or in combination with the method in FIG. 11A. The method comprises transmitting, from the core network node 16H to an authentication server 10A in the home network 10H, a transparent container 20 or a set of one or more information fields 22 contained in the transparent container 20, wherein the transparent container 20 acknowledges successful reception by the wireless device 12 of device configuration data 14 from the home network 10H (Block 1130). The method also comprises receiving integrity checking information 32 from the authentication server 10A (Block 1140). For example, the integrity checking information 32 may either: (i) indicate a result of a check by the authentication server 10A of the integrity of the set of one or more information fields 22; or (ii) be usable by the core network node 16H to check the integrity of the set of one or more information fields 22.

FIG. 11C depicts yet another method performed by a core network node 16H configured for use in a home network 10H of a wireless device 12 in accordance with still other particular embodiments. The method comprises receiving, from the wireless device 12, a transparent container 20 that acknowledges successful reception by the wireless device 12 of device configuration data 14 from the home network 10H, wherein the transparent container 20 contains integrity protection data 24 (Block 1150). The method further comprises checking whether the integrity protection data 24 corresponds to first expected integrity protection data or second expected integrity protection data, depending respectively on whether the transparent container 20 contains a set of one or more information fields 22 (Block 1160).

In some embodiments, the core network node 16H implements a unified data management, UDM, function.

In some embodiments, the transparent container 20 contains a header 20H. In some embodiments, the header 20H includes at least one information field 22H in the set of one or more information fields 22.

In some embodiments, the transparent container 20 contains a header 20H and a body 20B. In some embodiments, the body 20B includes at least one information field 22B in the set of one or more information fields 22.

In some embodiments, the device configuration data 14 includes steering of roaming information. In some embodiments, the steering of roaming information comprises information for encouraging the wireless device 12 to roam to a preferred roamed-to-network indicated by the home network 10H.

In some embodiments, the set of one or more information fields 22 includes an information field that indicates the wireless device 12 supports steering of roaming connected mode control information. In some embodiments, the steering of roaming connected mode control information comprises information to control timing for the wireless device 12 to move from connected mode to idle mode in order to perform steering of roaming.

In some embodiments, the device configuration data 14 includes a set of one or more device parameters. In one or more of these embodiments, the set of one or more device parameters includes a parameter that indicates default configured network slice selection assistance information, NSSAI. Additionally or alternatively, the set of one or more device parameters includes a parameter that indicates routing indicator data.

In some embodiments, the set of one or more information fields 22 includes an information field indicating that, or whether, the wireless device 12 supports a certain device parameter from the home network 10H.

In some embodiments, the device configuration data 14 includes User Equipment, UE, Parameter Update, UPU, data.

In some embodiments, the set of one or more information fields 22 includes a field indicating that, or whether, the wireless device 12 supports a certain parameter for UPU.

In some embodiments, the transparent container 18 acknowledges successful reception of the device configuration data 14 by acknowledging a successful security check of the device configuration data 14.

Embodiments herein also include corresponding apparatuses. Embodiments herein for instance include a wireless device 12 configured to perform any of the steps of any of the embodiments described above for the wireless device 12.

Embodiments also include a wireless device 12 comprising processing circuitry and power supply circuitry. The processing circuitry is configured to perform any of the steps of any of the embodiments described above for the wireless device 12. The power supply circuitry is configured to supply power to the wireless device 12.

Embodiments further include a wireless device 12 comprising processing circuitry. The processing circuitry is configured to perform any of the steps of any of the embodiments described above for the wireless device 12. In some embodiments, the wireless device 12 further comprises communication circuitry.

Embodiments further include a wireless device 12 comprising processing circuitry and memory. The memory contains instructions executable by the processing circuitry whereby the wireless device 12 is configured to perform any of the steps of any of the embodiments described above for the wireless device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include an authentication server 10A configured to perform any of the steps of any of the embodiments described above for the authentication server 10A.

Embodiments also include an authentication server 10A comprising processing circuitry and power supply circuitry. The processing circuitry is configured to perform any of the steps of any of the embodiments described above for the authentication server 10A. The power supply circuitry is configured to supply power to the authentication server 10A.

Embodiments further include an authentication server 10A comprising processing circuitry. The processing circuitry is configured to perform any of the steps of any of the embodiments described above for the authentication server 10A. In some embodiments, the authentication server 10A further comprises communication circuitry.

Embodiments further include an authentication server 10A comprising processing circuitry and memory. The memory contains instructions executable by the processing circuitry whereby the authentication server 10A is configured to perform any of the steps of any of the embodiments described above for the authentication server 10A.

Embodiments herein also include a core network node 16H configured to perform any of the steps of any of the embodiments described above for the core network node 16H.

Embodiments also include a core network node 16H comprising processing circuitry and power supply circuitry. The processing circuitry is configured to perform any of the steps of any of the embodiments described above for the core network node 16H. The power supply circuitry is configured to supply power to the core network node 16H.

Embodiments further include a core network node 16H comprising processing circuitry.

The processing circuitry is configured to perform any of the steps of any of the embodiments described above for the core network node 16H. In some embodiments, the core network node 16H further comprises communication circuitry.

Embodiments further include a core network node 16H comprising processing circuitry and memory. The memory contains instructions executable by the processing circuitry whereby the core network node 16H is configured to perform any of the steps of any of the embodiments described above for the core network node 16H.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

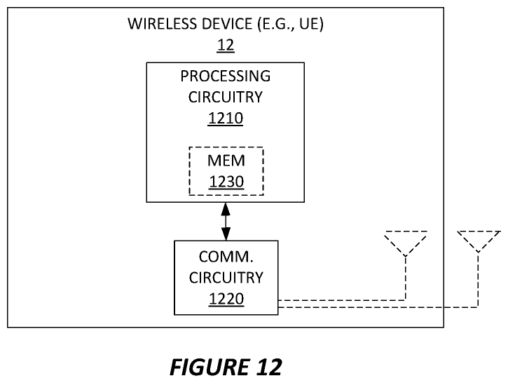

FIG. 12 for example illustrates a wireless device 12 as implemented in accordance with one or more embodiments. As shown, the wireless device 12 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the wireless device 12. The processing circuitry 1210 is configured to perform processing described above, e.g., in FIG. 9, such as by executing instructions stored in memory 1230. The processing circuitry 1210 in this regard may implement certain functional means, units, or modules.

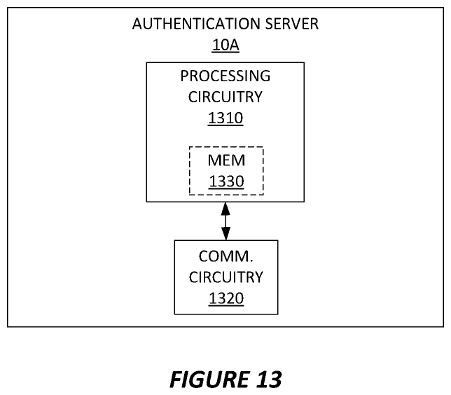

FIG. 13 illustrates an authentication server 10A as implemented in accordance with one or more embodiments. As shown, the authentication server 10A includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 10A and/or 10B, such as by executing instructions stored in memory 1330. The processing circuitry 1310 in this regard may implement certain functional means, units, or modules.

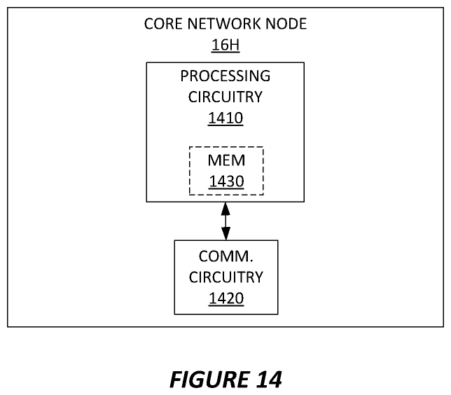

FIG. 14 illustrates a core network node 16H as implemented in accordance with one or more embodiments. As shown, the core network node 16H includes processing circuitry 1410 and communication circuitry 1420. The communication circuitry 1420 is configured to transmit and/or receive information to and/or from one or more other nodes, e.g., via any communication technology. The processing circuitry 1410 is configured to perform processing described above, e.g., in any of FIGS. 11A, 11B, and 11C, such as by executing instructions stored in memory 1430. The processing circuitry 1410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

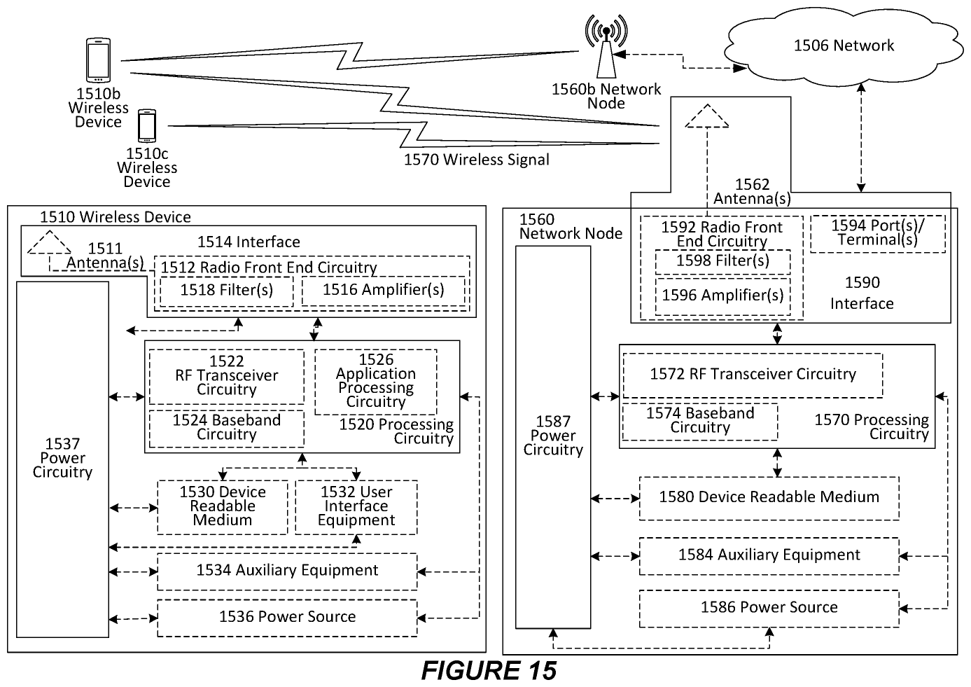

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 1506, network nodes 1560 and 1560b, and WDs 1510, 1510b, and 1510c. In practice, a wireless network may further include any additional elements suitable to support communication between wireless devices or between a wireless device and another communication device, such as a landline telephone, a service provider, or any other network node or end device. Of the illustrated components, network node 1560 and wireless device (WD) 1510 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1560 and WD 1510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 15, network node 1560 includes processing circuitry 1570, device readable medium 1580, interface 1590, auxiliary equipment 1584, power source 1586, power circuitry 1587, and antenna 1562. Although network node 1560 illustrated in the example wireless network of FIG. 15 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1560 are depicted as single boxes located within a larger box, or nested within multiple boxes, in practice, a network node may comprise multiple different physical components that make up a single illustrated component (e.g., device readable medium 1580 may comprise multiple separate hard drives as well as multiple RAM modules).

Similarly, network node 1560 may be composed of multiple physically separate components (e.g., a NodeB component and a RNC component, or a BTS component and a BSC component, etc.), which may each have their own respective components. In certain scenarios in which network node 1560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1560 may be configured to support multiple radio access technologies (RATs). In such embodiments, some components may be duplicated (e.g., separate device readable medium 1580 for the different RATs) and some components may be reused (e.g., the same antenna 1562 may be shared by the RATs). Network node 1560 may also include multiple sets of the various illustrated components for different wireless technologies integrated into network node 1560, such as, for example, GSM, WCDMA, LTE, NR, WiFi, or Bluetooth wireless technologies. These wireless technologies may be integrated into the same or different chip or set of chips and other components within network node 1560.

Processing circuitry 1570 is configured to perform any determining, calculating, or similar operations (e.g., certain obtaining operations) described herein as being provided by a network node. These operations performed by processing circuitry 1570 may include processing information obtained by processing circuitry 1570 by, for example, converting the obtained information into other information, comparing the obtained information or converted information to information stored in the network node, and/or performing one or more operations based on the obtained information or converted information, and as a result of said processing making a determination.

Processing circuitry 1570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1560 components, such as device readable medium 1580, network node 1560 functionality. For example, processing circuitry 1570 may execute instructions stored in device readable medium 1580 or in memory within processing circuitry 1570. Such functionality may include providing any of the various wireless features, functions, or benefits discussed herein. In some embodiments, processing circuitry 1570 may include a system on a chip (SOC).

In some embodiments, processing circuitry 1570 may include one or more of radio frequency (RF) transceiver circuitry 1572 and baseband processing circuitry 1574. In some embodiments, radio frequency (RF) transceiver circuitry 1572 and baseband processing circuitry 1574 may be on separate chips (or sets of chips), boards, or units, such as radio units and digital units. In alternative embodiments, part or all of RF transceiver circuitry 1572 and baseband processing circuitry 1574 may be on the same chip or set of chips, boards, or units

In certain embodiments, some or all of the functionality described herein as being provided by a network node, base station, eNB or other such network device may be performed by processing circuitry 1570 executing instructions stored on device readable medium 1580 or memory within processing circuitry 1570. In alternative embodiments, some or all of the functionality may be provided by processing circuitry 1570 without executing instructions stored on a separate or discrete device readable medium, such as in a hard-wired manner. In any of those embodiments, whether executing instructions stored on a device readable storage medium or not, processing circuitry 1570 can be configured to perform the described functionality. The benefits provided by such functionality are not limited to processing circuitry 1570 alone or to other components of network node 1560, but are enjoyed by network node 1560 as a whole, and/or by end users and the wireless network generally.

Device readable medium 1580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1570. Device readable medium 1580 may store any suitable instructions, data or information, including a computer program, software, an application including one or more of logic, rules, code, tables, etc. and/or other instructions capable of being executed by processing circuitry 1570 and, utilized by network node 1560. Device readable medium 1580 may be used to store any calculations made by processing circuitry 1570 and/or any data received via interface 1590. In some embodiments, processing circuitry 1570 and device readable medium 1580 may be considered to be integrated.

Interface 1590 is used in the wired or wireless communication of signalling and/or data between network node 1560, network 1506, and/or WDs 1510. As illustrated, interface 1590 comprises port(s)/terminal(s) 1594 to send and receive data, for example to and from network 1506 over a wired connection. Interface 1590 also includes radio front end circuitry 1592 that may be coupled to, or in certain embodiments a part of, antenna 1562. Radio front end circuitry 1592 comprises filters 1598 and amplifiers 1596. Radio front end circuitry 1592 may be connected to antenna 1562 and processing circuitry 1570. Radio front end circuitry may be configured to condition signals communicated between antenna 1562 and processing circuitry 1570. Radio front end circuitry 1592 may receive digital data that is to be sent out to other network nodes or WDs via a wireless connection. Radio front end circuitry 1592 may convert the digital data into a radio signal having the appropriate channel and bandwidth parameters using a combination of filters 1598 and/or amplifiers 1596. The radio signal may then be transmitted via antenna 1562. Similarly, when receiving data, antenna 1562 may collect radio signals which are then converted into digital data by radio front end circuitry 1592. The digital data may be passed to processing circuitry 1570. In other embodiments, the interface may comprise different components and/or different combinations of components.

In certain alternative embodiments, network node 1560 may not include separate radio front end circuitry 1592, instead, processing circuitry 1570 may comprise radio front end circuitry and may be connected to antenna 1562 without separate radio front end circuitry 1592. Similarly, in some embodiments, all or some of RF transceiver circuitry 1572 may be considered a part of interface 1590. In still other embodiments, interface 1590 may include one or more ports or terminals 1594, radio front end circuitry 1592, and RF transceiver circuitry 1572, as part of a radio unit (not shown), and interface 1590 may communicate with baseband processing circuitry 1574, which is part of a digital unit (not shown).

Antenna 1562 may include one or more antennas, or antenna arrays, configured to send and/or receive wireless signals. Antenna 1562 may be coupled to radio front end circuitry 1590 and may be any type of antenna capable of transmitting and receiving data and/or signals wirelessly. In some embodiments, antenna 1562 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1562 may be separate from network node 1560 and may be connectable to network node 1560 through an interface or port.

Antenna 1562, interface 1590, and/or processing circuitry 1570 may be configured to perform any receiving operations and/or certain obtaining operations described herein as being performed by a network node. Any information, data and/or signals may be received from a wireless device, another network node and/or any other network equipment. Similarly, antenna 1562, interface 1590, and/or processing circuitry 1570 may be configured to perform any transmitting operations described herein as being performed by a network node. Any information, data and/or signals may be transmitted to a wireless device, another network node and/or any other network equipment.

Power circuitry 1587 may comprise, or be coupled to, power management circuitry and is configured to supply the components of network node 1560 with power for performing the functionality described herein. Power circuitry 1587 may receive power from power source 1586. Power source 1586 and/or power circuitry 1587 may be configured to provide power to the various components of network node 1560 in a form suitable for the respective components (e.g., at a voltage and current level needed for each respective component). Power source 1586 may either be included in, or external to, power circuitry 1587 and/or network node 1560. For example, network node 1560 may be connectable to an external power source (e.g., an electricity outlet) via an input circuitry or interface such as an electrical cable, whereby the external power source supplies power to power circuitry 1587. As a further example, power source 1586 may comprise a source of power in the form of a battery or battery pack which is connected to, or integrated in, power circuitry 1587. The battery may provide backup power should the external power source fail. Other types of power sources, such as photovoltaic devices, may also be used.

Alternative embodiments of network node 1560 may include additional components beyond those shown in FIG. 15 that may be responsible for providing certain aspects of the network node's functionality, including any of the functionality described herein and/or any functionality necessary to support the subject matter described herein. For example, network node 1560 may include user interface equipment to allow input of information into network node 1560 and to allow output of information from network node 1560. This may allow a user to perform diagnostic, maintenance, repair, and other administrative functions for network node 1560.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1510 includes antenna 1511, interface 1514, processing circuitry 1520, device readable medium 1530, user interface equipment 1532, auxiliary equipment 1534, power source 1536 and power circuitry 1537. WD 1510 may include multiple sets of one or more of the illustrated components for different wireless technologies supported by WD 1510, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1510.

Antenna 1511 may include one or more antennas or antenna arrays, configured to send and/or receive wireless signals, and is connected to interface 1514. In certain alternative embodiments, antenna 1511 may be separate from WD 1510 and be connectable to WD 1510 through an interface or port. Antenna 1511, interface 1514, and/or processing circuitry 1520 may be configured to perform any receiving or transmitting operations described herein as being performed by a WD. Any information, data and/or signals may be received from a network node and/or another WD. In some embodiments, radio front end circuitry and/or antenna 1511 may be considered an interface.

As illustrated, interface 1514 comprises radio front end circuitry 1512 and antenna 1511. Radio front end circuitry 1512 comprise one or more filters 1518 and amplifiers 1516. Radio front end circuitry 1514 is connected to antenna 1511 and processing circuitry 1520, and is configured to condition signals communicated between antenna 1511 and processing circuitry 1520. Radio front end circuitry 1512 may be coupled to or a part of antenna 1511. In some embodiments, WD 1510 may not include separate radio front end circuitry 1512; rather, processing circuitry 1520 may comprise radio front end circuitry and may be connected to antenna 1511. Similarly, in some embodiments, some or all of RF transceiver circuitry 1522 may be considered a part of interface 1514. Radio front end circuitry 1512 may receive digital data that is to be sent out to other network nodes or WDs via a wireless connection. Radio front end circuitry 1512 may convert the digital data into a radio signal having the appropriate channel and bandwidth parameters using a combination of filters 1518 and/or amplifiers 1516. The radio signal may then be transmitted via antenna 1511. Similarly, when receiving data, antenna 1511 may collect radio signals which are then converted into digital data by radio front end circuitry 1512. The digital data may be passed to processing circuitry 1520. In other embodiments, the interface may comprise different components and/or different combinations of components.

Processing circuitry 1520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1510 components, such as device readable medium 1530, WD 1510 functionality. Such functionality may include providing any of the various wireless features or benefits discussed herein. For example, processing circuitry 1520 may execute instructions stored in device readable medium 1530 or in memory within processing circuitry 1520 to provide the functionality disclosed herein.

As illustrated, processing circuitry 1520 includes one or more of RF transceiver circuitry 1522, baseband processing circuitry 1524, and application processing circuitry 1526. In other embodiments, the processing circuitry may comprise different components and/or different combinations of components. In certain embodiments processing circuitry 1520 of WD 1510 may comprise a SOC. In some embodiments, RF transceiver circuitry 1522, baseband processing circuitry 1524, and application processing circuitry 1526 may be on separate chips or sets of chips. In alternative embodiments, part or all of baseband processing circuitry 1524 and application processing circuitry 1526 may be combined into one chip or set of chips, and RF transceiver circuitry 1522 may be on a separate chip or set of chips. In still alternative embodiments, part or all of RF transceiver circuitry 1522 and baseband processing circuitry 1524 may be on the same chip or set of chips, and application processing circuitry 1526 may be on a separate chip or set of chips. In yet other alternative embodiments, part or all of RF transceiver circuitry 1522, baseband processing circuitry 1524, and application processing circuitry 1526 may be combined in the same chip or set of chips. In some embodiments, RF transceiver circuitry 1522 may be a part of interface 1514. RF transceiver circuitry 1522 may condition RF signals for processing circuitry 1520.

In certain embodiments, some or all of the functionality described herein as being performed by a WD may be provided by processing circuitry 1520 executing instructions stored on device readable medium 1530, which in certain embodiments may be a computer-readable storage medium. In alternative embodiments, some or all of the functionality may be provided by processing circuitry 1520 without executing instructions stored on a separate or discrete device readable storage medium, such as in a hard-wired manner. In any of those particular embodiments, whether executing instructions stored on a device readable storage medium or not, processing circuitry 1520 can be configured to perform the described functionality. The benefits provided by such functionality are not limited to processing circuitry 1520 alone or to other components of WD 1510, but are enjoyed by WD 1510 as a whole, and/or by end users and the wireless network generally.

Processing circuitry 1520 may be configured to perform any determining, calculating, or similar operations (e.g., certain obtaining operations) described herein as being performed by a WD. These operations, as performed by processing circuitry 1520, may include processing information obtained by processing circuitry 1520 by, for example, converting the obtained information into other information, comparing the obtained information or converted information to information stored by WD 1510, and/or performing one or more operations based on the obtained information or converted information, and as a result of said processing making a determination.

Device readable medium 1530 may be operable to store a computer program, software, an application including one or more of logic, rules, code, tables, etc. and/or other instructions capable of being executed by processing circuitry 1520. Device readable medium 1530 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1520. In some embodiments, processing circuitry 1520 and device readable medium 1530 may be considered to be integrated.

User interface equipment 1532 may provide components that allow for a human user to interact with WD 1510. Such interaction may be of many forms, such as visual, audial, tactile, etc. User interface equipment 1532 may be operable to produce output to the user and to allow the user to provide input to WD 1510. The type of interaction may vary depending on the type of user interface equipment 1532 installed in WD 1510. For example, if WD 1510 is a smart phone, the interaction may be via a touch screen; if WD 1510 is a smart meter, the interaction may be through a screen that provides usage (e.g., the number of gallons used) or a speaker that provides an audible alert (e.g., if smoke is detected). User interface equipment 1532 may include input interfaces, devices and circuits, and output interfaces, devices and circuits. User interface equipment 1532 is configured to allow input of information into WD 1510, and is connected to processing circuitry 1520 to allow processing circuitry 1520 to process the input information. User interface equipment 1532 may include, for example, a microphone, a proximity or other sensor, keys/buttons, a touch display, one or more cameras, a USB port, or other input circuitry. User interface equipment 1532 is also configured to allow output of information from WD 1510, and to allow processing circuitry 1520 to output information from WD 1510. User interface equipment 1532 may include, for example, a speaker, a display, vibrating circuitry, a USB port, a headphone interface, or other output circuitry. Using one or more input and output interfaces, devices, and circuits, of user interface equipment 1532, WD 1510 may communicate with end users and/or the wireless network, and allow them to benefit from the functionality described herein.

Auxiliary equipment 1534 is operable to provide more specific functionality which may not be generally performed by WDs. This may comprise specialized sensors for doing measurements for various purposes, interfaces for additional types of communication such as wired communications etc. The inclusion and type of components of auxiliary equipment 1534 may vary depending on the embodiment and/or scenario.

Power source 1536 may, in some embodiments, be in the form of a battery or battery pack. Other types of power sources, such as an external power source (e.g., an electricity outlet), photovoltaic devices or power cells, may also be used. WD 1510 may further comprise power circuitry 1537 for delivering power from power source 1536 to the various parts of WD 1510 which need power from power source 1536 to carry out any functionality described or indicated herein. Power circuitry 1537 may in certain embodiments comprise power management circuitry. Power circuitry 1537 may additionally or alternatively be operable to receive power from an external power source; in which case WD 1510 may be connectable to the external power source (such as an electricity outlet) via input circuitry or an interface such as an electrical power cable. Power circuitry 1537 may also in certain embodiments be operable to deliver power from an external power source to power source 1536. This may be, for example, for the charging of power source 1536. Power circuitry 1537 may perform any formatting, converting, or other modification to the power from power source 1536 to make the power suitable for the respective components of WD 1510 to which power is supplied.

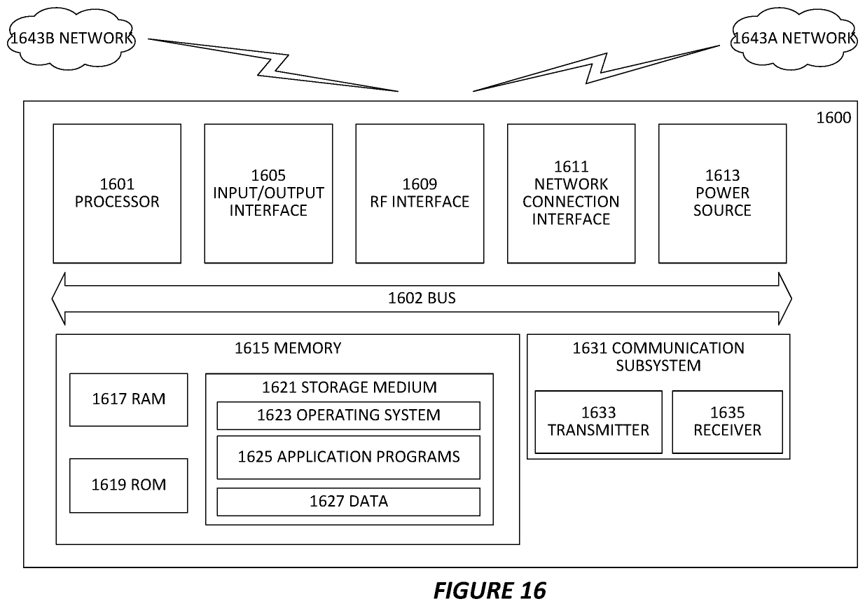

FIG. 16 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 16200 may be any UE identified by the 3^{rd} Generation Partnership Project (3GPP), including a NB-IoT UE, a machine type communication (MTC) UE, and/or an enhanced MTC (eMTC) UE. UE 1600, as illustrated in FIG. 16, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 16 is a UE, the components discussed herein are equally applicable to a WD, and vice-versa.

In FIG. 16, UE 1600 includes processing circuitry 1601 that is operatively coupled to input/output interface 1605, radio frequency (RF) interface 1609, network connection interface 1611, memory 1615 including random access memory (RAM) 1617, read-only memory (ROM) 1619, and storage medium 1621 or the like, communication subsystem 1631, power source 1633, and/or any other component, or any combination thereof. Storage medium 1621 includes operating system 1623, application program 1625, and data 1627. In other embodiments, storage medium 1621 may include other similar types of information. Certain UEs may utilize all of the components shown in FIG. 16, or only a subset of the components. The level of integration between the components may vary from one UE to another UE. Further, certain UEs may contain multiple instances of a component, such as multiple processors, memories, transceivers, transmitters, receivers, etc.

In FIG. 16, processing circuitry 1601 may be configured to process computer instructions and data. Processing circuitry 1601 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1601 may include two central processing units (CPUs). Data may be information in a form suitable for use by a computer.

In the depicted embodiment, input/output interface 1605 may be configured to provide a communication interface to an input device, output device, or input and output device. UE 1600 may be configured to use an output device via input/output interface 1605. An output device may use the same type of interface port as an input device. For example, a USB port may be used to provide input to and output from UE 1600. The output device may be a speaker, a sound card, a video card, a display, a monitor, a printer, an actuator, an emitter, a smartcard, another output device, or any combination thereof. UE 1600 may be configured to use an input device via input/output interface 1605 to allow a user to capture information into UE 1600. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 16, RF interface 1609 may be configured to provide a communication interface to RF components such as a transmitter, a receiver, and an antenna. Network connection interface 1611 may be configured to provide a communication interface to network 1643a. Network 1643a may encompass wired and/or wireless networks such as a local-area network (LAN), a wide-area network (WAN), a computer network, a wireless network, a telecommunications network, another like network or any combination thereof. For example, network 1643a may comprise a Wi-Fi network. Network connection interface 1611 may be configured to include a receiver and a transmitter interface used to communicate with one or more other devices over a communication network according to one or more communication protocols, such as Ethernet, TCP/IP, SONET, ATM, or the like. Network connection interface 1611 may implement receiver and transmitter functionality appropriate to the communication network links (e.g., optical, electrical, and the like). The transmitter and receiver functions may share circuit components, software or firmware, or alternatively may be implemented separately.

RAM 1617 may be configured to interface via bus 1602 to processing circuitry 1601 to provide storage or caching of data or computer instructions during the execution of software programs such as the operating system, application programs, and device drivers. ROM 1619 may be configured to provide computer instructions or data to processing circuitry 1601. For example, ROM 1619 may be configured to store invariant low-level system code or data for basic system functions such as basic input and output (I/O), startup, or reception of keystrokes from a keyboard that are stored in a non-volatile memory. Storage medium 1621 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1621 may be configured to include operating system 1623, application program 1625 such as a web browser application, a widget or gadget engine or another application, and data file 1627. Storage medium 1621 may store, for use by UE 1600, any of a variety of various operating systems or combinations of operating systems.

Storage medium 1621 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1621 may allow UE 1600 to access computer-executable instructions, application programs or the like, stored on transitory or non-transitory memory media, to off-load data, or to upload data. An article of manufacture, such as one utilizing a communication system may be tangibly embodied in storage medium 1621, which may comprise a device readable medium.

In FIG. 16, processing circuitry 1601 may be configured to communicate with network 1643b using communication subsystem 1631. Network 1643a and network 1643b may be the same network or networks or different network or networks. Communication subsystem 1631 may be configured to include one or more transceivers used to communicate with network 1643b. For example, communication subsystem 1631 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1633 and/or receiver 1635 to implement transmitter or receiver functionality, respectively, appropriate to the RAN links (e.g., frequency allocations and the like). Further, transmitter 1633 and receiver 1635 of each transceiver may share circuit components, software or firmware, or alternatively may be implemented separately.

In the illustrated embodiment, the communication functions of communication subsystem 1631 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1631 may include cellular communication, Wi-Fi communication, Bluetooth communication, and GPS communication. Network 1643b may encompass wired and/or wireless networks such as a local-area network (LAN), a wide-area network (WAN), a computer network, a wireless network, a telecommunications network, another like network or any combination thereof. For example, network 1643b may be a cellular network, a Wi-Fi network, and/or a near-field network. Power source 1613 may be configured to provide alternating current (AC) or direct current (DC) power to components of UE 1600.

The features, benefits and/or functions described herein may be implemented in one of the components of UE 1600 or partitioned across multiple components of UE 1600. Further, the features, benefits, and/or functions described herein may be implemented in any combination of hardware, software or firmware. In one example, communication subsystem 1631 may be configured to include any of the components described herein. Further, processing circuitry 1601 may be configured to communicate with any of such components over bus 1602. In another example, any of such components may be represented by program instructions stored in memory that when executed by processing circuitry 1601 perform the corresponding functions described herein. In another example, the functionality of any of such components may be partitioned between processing circuitry 1601 and communication subsystem 1631. In another example, the non-computationally intensive functions of any of such components may be implemented in software or firmware and the computationally intensive functions may be implemented in hardware.

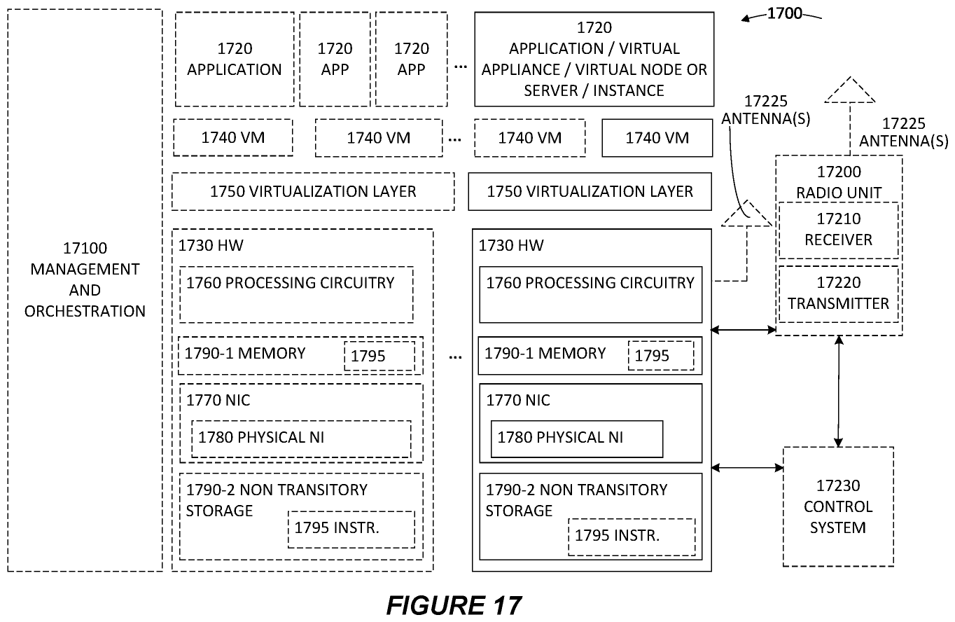

FIG. 17 is a schematic block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1700 hosted by one or more of hardware nodes 1730. Further, in embodiments in which the virtual node is not a radio access node or does not require radio connectivity (e.g., a core network node), then the network node may be entirely virtualized.

The functions may be implemented by one or more applications 1720 (which may alternatively be called software instances, virtual appliances, network functions, virtual nodes, virtual network functions, etc.) operative to implement some of the features, functions, and/or benefits of some of the embodiments disclosed herein. Applications 1720 are run in virtualization environment 1700 which provides hardware 1730 comprising processing circuitry 1760 and memory 1790. Memory 1790 contains instructions 1795 executable by processing circuitry 1760 whereby application 1720 is operative to provide one or more of the features, benefits, and/or functions disclosed herein.

Virtualization environment 1700, comprises general-purpose or special-purpose network hardware devices 1730 comprising a set of one or more processors or processing circuitry 1760, which may be commercial off-the-shelf (COTS) processors, dedicated Application Specific Integrated Circuits (ASICs), or any other type of processing circuitry including digital or analog hardware components or special purpose processors. Each hardware device may comprise memory 1790-1 which may be non-persistent memory for temporarily storing instructions 1795 or software executed by processing circuitry 1760. Each hardware device may comprise one or more network interface controllers (NICs) 1770, also known as network interface cards, which include physical network interface 1780. Each hardware device may also include non-transitory, persistent, machine-readable storage media 1790-2 having stored therein software 1795 and/or instructions executable by processing circuitry 1760. Software 1795 may include any type of software including software for instantiating one or more virtualization layers 1750 (also referred to as hypervisors), software to execute virtual machines 1740 as well as software allowing it to execute functions, features and/or benefits described in relation with some embodiments described herein.

Virtual machines 1740, comprise virtual processing, virtual memory, virtual networking or interface and virtual storage, and may be run by a corresponding virtualization layer 1750 or hypervisor. Different embodiments of the instance of virtual appliance 1720 may be implemented on one or more of virtual machines 1740, and the implementations may be made in different ways.

During operation, processing circuitry 1760 executes software 1795 to instantiate the hypervisor or virtualization layer 1750, which may sometimes be referred to as a virtual machine monitor (VMM). Virtualization layer 1750 may present a virtual operating platform that appears like networking hardware to virtual machine 1740.

As shown in FIG. 17, hardware 1730 may be a standalone network node with generic or specific components. Hardware 1730 may comprise antenna 17225 and may implement some functions via virtualization. Alternatively, hardware 1730 may be part of a larger cluster of hardware (e.g. such as in a data center or customer premise equipment (CPE)) where many hardware nodes work together and are managed via management and orchestration (MANO) 17100, which, among others, oversees lifecycle management of applications 1720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1740 may be a software implementation of a physical machine that runs programs as if they were executing on a physical, non-virtualized machine. Each of virtual machines 1740, and that part of hardware 1730 that executes that virtual machine, be it hardware dedicated to that virtual machine and/or hardware shared by that virtual machine with others of the virtual machines 1740, forms a separate virtual network elements (VNE).

Still in the context of NFV, Virtual Network Function (VNF) is responsible for handling specific network functions that run in one or more virtual machines 1740 on top of hardware networking infrastructure 1730 and corresponds to application 1720 in FIG. 17.

In some embodiments, one or more radio units 17200 that each include one or more transmitters 17220 and one or more receivers 17210 may be coupled to one or more antennas 17225. Radio units 17200 may communicate directly with hardware nodes 1730 via one or more appropriate network interfaces and may be used in combination with the virtual components to provide a virtual node with radio capabilities, such as a radio access node or a base station.

In some embodiments, some signalling can be effected with the use of control system 17230 which may alternatively be used for communication between the hardware nodes 1730 and radio units 17200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless device, the method comprising:
   receiving device configuration data from a home network of the wireless device; and
   transmitting a transparent container that acknowledges successful reception of the device configuration data, contains a set of one or more information fields, and contains integrity protection data that integrity protects the set of one or more information fields.
A2. The method of embodiment A1, wherein the transparent container contains a header, wherein the header includes at least one information field in the set of one or more information fields integrity protected by the integrity protection data.
A3. The method of embodiment A2, wherein the integrity protection data integrity protects the header.
A4. The method of any of embodiments A1-A3, wherein the transparent container contains a header and a body, and wherein the body includes at least one information field in the set of one or more information fields integrity protected by the integrity protection data.
A5. The method of any of embodiments A1-A4, wherein the transparent container contains a header and a body, wherein the header includes at least one information field in the set of one or more information fields integrity protected by the integrity protection data, and wherein the body includes at least one information field in the set of one or more information fields integrity protected by the integrity protection data.
A6. The method of embodiment A5, wherein the body includes the integrity protection data, and wherein the integrity protection data integrity protects the header and integrity protects all of the body except the integrity protection data.
A7. The method of any of embodiments A1-A6, wherein the integrity protection data integrity protects the whole transparent container except for the integrity protection data.
A8. The method of any of embodiments A1-A7, further comprising generating the transparent container to be included in the uplink control plane message by:
   generating an intermediate transparent container that contains the set of one or more information fields;
   generating the integrity protection data to integrity protect the intermediate transparent container that contains the set of one or more information fields; and
   adding the integrity protection data to the intermediate transparent container to form the transparent container to be included in the uplink control plane message.
A9. The method of any of embodiments A1-A8, wherein the device configuration data includes steering of roaming information, wherein the steering of roaming information comprises information for encouraging the wireless device to roam to a preferred roamed-to-network indicated by the home network.
A10. The method of any of embodiments A1-A9, wherein the set of one or more information fields includes an information field that indicates the wireless device supports steering of roaming connected mode control information, wherein the steering of roaming connected mode control information comprises information to control timing for the wireless device to move from connected mode to idle mode in order to perform steering of roaming.
A11. The method of any of embodiments A1-A10, wherein the integrity protection data comprises SoR-MAC-I_{UE}.
A12. The method of any of embodiments A1-A8, wherein the device configuration data includes a set of one or more device parameters.
A13. The method of embodiment A12, wherein the set of one or more device parameters includes:
   a parameter that indicates default configured network slice selection assistance information, NSSAI; and/or
   a parameter that indicates routing indicator data.
A14. The method of any of embodiments A1-A8 and A12-A13, wherein the set of one or more information fields includes an information field indicating that, or whether, the wireless device supports a certain device parameter from the home network.
A15. The method of any of embodiments A1-A8 and A12-A14, wherein the device configuration data includes User Equipment, UE, Parameter Update, UPU, data.
A16. The method of any of embodiments A1-A8 and A12-A15, wherein the set of one or more information fields includes a field indicating that, or whether, the wireless device supports a certain parameter for UPU.
A17. The method of any of embodiments A1-A8 and A12-A16, wherein the integrity protection data comprises UPU-MAC-I_{UE}.
A18. The method of any of embodiments A1-A17, wherein the integrity protection data comprises a message authentication code, MAC.
A19. The method of any of embodiments A1-A14, further comprising generating the integrity protection data from the set of one or more information fields.
A20. The method of embodiment A19, wherein generating the integrity protection data comprises:
   forming an input to a key derivation function from a set of input parameters, wherein the set of input parameters includes at least the set of one or more information fields;
   calculating an output of the key derivation function with the formed input; and
   generating the integrity protection data from the output of the key derivation function.
A21. The method of embodiment A20, wherein the transparent container contains a header, wherein the header includes at least one information field in the set of one or more information fields integrity protected by the integrity protection data, and wherein the set of input parameters includes the header.
A22. The method of any of embodiments A20-A21, wherein the transparent container contains a header and a body, and wherein the body includes at least one information field in the set of one or more information fields integrity protected by the integrity protection data, and wherein the set of input parameters includes the body except for the integrity protection data.
A23. The method of any of embodiments A20-A22, wherein the set of input parameters includes the whole transparent container except for the integrity protection data.
A24. The method of any of embodiments A20-A23, wherein the set of input parameters includes:
   an FC parameter equal to 0x78;
   a P0 parameter equal to a P0 input value, wherein the P0 input value includes at least the set of one or more information fields;
   an L0 parameter equal to a length of the P0 input value;
   a P1 parameter equal to a counter; and
   an L1 parameter equal to a length of the counter.
A25. The method of any of embodiments A1-A24, further comprising performing a security check of the device configuration data, wherein the security check includes checking an integrity of the device configuration data, and wherein the transparent container acknowledges successful reception of the device configuration data by acknowledging a successful security check of the device configuration data.
A26. The method of any of embodiments A1-A25, wherein said receiving comprises receiving, from a first core network node in a serving network of the wireless device, a downlink control plane message that includes the device configuration data, and wherein said transmitting comprises transmitting, to the first core network node, an uplink control plane message that includes the transparent container, wherein the transparent container is to be forwarded to a second core network node in the home network.
A27. The method of embodiment A26, wherein the downlink control plane message is a downlink non-access stratum transport message, and wherein the uplink control plane message is an uplink non-access stratum transport message.
A28. The method of any of embodiments A26-A27, wherein the first core network node implements an access and mobility function, AMF.
A29. The method of any of embodiments A26-A28, wherein the second core network node implements a unified data management, UDM, function.
A30. The method of any of embodiments A1-A29, wherein said receiving comprises receiving the device configuration data from a core network node in the home network, and wherein said transmitting comprises transmitting the transparent container towards the core network node in the home network.

### Group B Embodiments

1. A method performed by an authentication server configured for use in a home network of a wireless device, the method comprising:
   generating expected integrity protection data for checking an integrity of a set of one or more information fields contained in a transparent container that acknowledges successful reception by the wireless device of device configuration data from the home network; and
   checking, or assisting a core network node in the home network to check, the integrity of the set of one or more information fields using the expected integrity protection data.
B2. The method of embodiment 1, wherein the transparent container contains a header, wherein the header includes at least one information field in the set of one or more information fields, and wherein said generating comprises generating the expected integrity protection data from the at least one information field.
B3. The method of embodiment B2, wherein said generating comprises generating the expected integrity protection data from the header.
B4. The method of any of embodiments B1-B3, wherein the transparent container contains a header and a body, wherein the body includes at least one information field in the set of one or more information fields, and wherein said generating comprises generating the expected integrity protection data from the at least one information field.
B5. The method of any of embodiments B1-B4, wherein the transparent container contains a header and a body, wherein the header includes at least one information field in the set of one or more information fields, and wherein the body includes at least one information field in the set of one or more information fields, and wherein said generating comprises generating the expected integrity protection data from the at least one information field included in the header and from the at least one information field included in the body.
B6. The method of embodiment B5, wherein the body includes the integrity protection data, and wherein said generating comprises generating the expected integrity protection data from all of the body except the integrity protection data.
B7. The method of any of embodiments B1-B6, wherein said generating comprises generating the expected integrity protection data from the whole transparent container except for the integrity protection data.
B8. The method of any of embodiments B1-B7, wherein the device configuration data includes steering of roaming information, wherein the steering of roaming information comprises information for encouraging the wireless device to roam to a preferred roamed-to-network indicated by the home network.
B9. The method of any of embodiments B1-B8, wherein the set of one or more information fields includes an information field that indicates the wireless device supports steering of roaming connected mode control information, wherein the steering of roaming connected mode control information comprises information to control timing for the wireless device to move from connected mode to idle mode in order to perform steering of roaming.
B10. The method of any of embodiments B1-B9, wherein the expected integrity protection data comprises SoR-XMAC-IUE.
B11. The method of any of embodiments B1-B7, wherein the device configuration data includes a set of one or more device parameters.
B12. The method of embodiment 11, wherein the set of one or more device parameters includes:
   a parameter that indicates default configured network slice selection assistance information, NSSAI; and/or
   a parameter that indicates routing indicator data.
B13. The method of any of embodiments B1-B7 and B11-B12, wherein the set of one or more information fields includes an information field indicating that, or whether, the wireless device supports a certain device parameter from the home network.
B14. The method of any of embodiments B1-B7 and B11-B113, wherein the device configuration data includes User Equipment, UE, Parameter Update, UPU, data.
B15. The method of any of embodiments B1-B7 and B11-B14, wherein the set of one or more information fields includes a field indicating that, or whether, the wireless device supports a certain parameter for UPU.
B16. The method of any of embodiments B1-B7 and B11-B115, wherein the expected integrity protection data comprises UPU-XMAC-I_{UE}.
B17. The method of any of embodiments B1-B16, wherein the expected integrity protection data comprises an expected message authentication code, XMAC.
B18. The method of any of embodiments B1-B17, wherein said generating comprises generating the expected integrity protection data from the set of one or more information fields.
B19. The method of embodiment B18, wherein generating the expected integrity protection data comprises:
   forming an input to a key derivation function from a set of input parameters, wherein the set of input parameters includes at least the set of one or more information fields;
   calculating an output of the key derivation function with the formed input; and
   generating the expected integrity protection data from the output of the key derivation function.
B20. The method of embodiment B19, wherein the transparent container contains a header, wherein the header includes at least one information field in the set of one or more information fields, and wherein the set of input parameters includes the header.
B21. The method of any of embodiments 19-B20, wherein the transparent container contains a header and a body, and wherein the body includes at least one information field in the set of one or more information fields, and wherein the set of input parameters includes the body except for the integrity protection data.
B22. The method of any of embodiments B19-B21, wherein the set of input parameters includes the whole transparent container except for the integrity protection data.
B23. The method of any of embodiments B19-B22, wherein the set of input parameters includes:
   an FC parameter equal to 0x78;
   a P0 parameter equal to a P0 input value, wherein the P0 input value includes at least the set of one or more information fields;
   an L0 parameter equal to a length of the P0 input value;
   a P1 parameter equal to a counter; and
   an L1 parameter equal to a length of the counter.
B24. The method of any of embodiments B1-B23, wherein the transparent container acknowledges successful reception of the device configuration data by acknowledging a successful security check of the device configuration data.
B25. The method of any of embodiments B1-B24, wherein the downlink control plane message is a downlink non-access stratum transport message, and wherein the uplink control plane message is an uplink non-access stratum transport message.
B26. The method of any of embodiments B1-B25, further comprising receiving the transparent container, or the set of one or more information fields, from the core network node, as received by the core network node from the wireless device.
B27. The method of embodiment B26, wherein said generating comprises generating the expected integrity protection data from the transparent container, or the set of one or more information fields, received from the core network node.
B28. The method of any of embodiments B1-B26, wherein said generating comprises generating the expected integrity protection data after the home network receives the transparent container from the wireless device.
B29. The method of any of embodiments B1-B26, wherein said generating comprises, before the home network receives the transparent container from the wireless device, generating the expected integrity protection data from an expected transparent container, or an expected set of one or more information fields, that is expected to be received by the home network from the wireless device.
B30. The method of any of embodiments B1-B29, wherein said checking, or assisting a core network node in the home network to check, the integrity of the set of one or more information fields comprises checking the integrity of the set of one or more information fields, and wherein the method further comprises transmitting, to the core network node in the home network, information indicating a result of said checking.
B31. The method of any of embodiments B1-B29, wherein said checking, or assisting a core network node in the home network to check, the integrity of the set of one or more information fields comprises assisting the core network node to check the integrity of the set of one or more information fields, wherein said assisting comprises transmitting the expected integrity protection data to the core network node.
B32. The method of any of embodiments B1-B31, wherein the core network node implements a unified data management, UDM, function.
B11. A method performed by an authentication server configured for use in a home network of a wireless device, the method comprising:
   receiving, from a core network node in the home network, a transparent container or a set of one or more information fields contained in the transparent container, wherein the transparent container acknowledges successful reception by the wireless device of device configuration data from the home network; and
   checking, or assisting the core network node to check, the integrity of the set of one or more information fields.
BB2. The method of embodiment B1l, wherein said checking, or assisting the core network node to check, the integrity of the set of one or more information fields comprises checking the integrity of the set of one or more information fields, and wherein the method further comprises transmitting, to the core network node, information indicating a result of said checking.
BB3. The method of embodiment B1E, wherein said checking, or assisting the core network node to check, the integrity of the set of one or more information fields comprises assisting the core network node to check the integrity of the set of one or more information fields, wherein said assisting comprises transmitting expected integrity protection data to the core network node.
BB4. The method of any of embodiments BB1-BB2, wherein the core network node implements a unified data management, UDM, function.
BB6. The method of any of embodiments BB1-BB5, wherein the transparent container contains a header, wherein the header includes at least one information field in the set of one or more information fields, and wherein said checking, or assisting the core network node to check, the integrity of the set of one or more information fields comprises checking, or assisting the core network node to check, the integrity of the header.
BB7. The method of any of embodiments BB1-BB6, wherein the transparent container contains a header and a body, wherein the body includes at least one information field in the set of one or more information fields, and wherein said checking, or assisting the core network node to check, the integrity of the set of one or more information fields comprises checking, or assisting the core network node to check, the integrity of the at least one information field in the body.
BB8. The method of any of embodiments BB11-B7, wherein the transparent container contains a header and a body, wherein the header includes at least one information field in the set of one or more information fields, and wherein the body includes at least one information field in the set of one or more information fields, and wherein said checking, or assisting the core network node to check, the integrity of the at least one information field included in the header and the at least one information field included in the body.
BB9. The method of any of embodiments BB1-BB8, wherein the device configuration data includes steering of roaming information, wherein the steering of roaming information comprises information for encouraging the wireless device to roam to a preferred roamed-to-network indicated by the home network.
BB10. The method of any of embodiments BB1-BB9, wherein the set of one or more information fields includes an information field that indicates the wireless device supports steering of roaming connected mode control information, wherein the steering of roaming connected mode control information comprises information to control timing for the wireless device to move from connected mode to idle mode in order to perform steering of roaming.
BB11. The method of any of embodiments BB1-BB10, wherein the device configuration data includes a set of one or more device parameters.
BB12. The method of embodiment BB11, wherein the set of one or more device parameters includes:
   a parameter that indicates default configured network slice selection assistance information, NSSAI; and/or
   a parameter that indicates routing indicator data.
BB13. The method of any of embodiments BB1-BB8 and BB11-BB12, wherein the set of one or more information fields includes an information field indicating that, or whether, the wireless device supports a certain device parameter from the home network.
BB14. The method of any of embodiments BB1-BB8 and BB11-BB13, wherein the device configuration data includes User Equipment, UE, Parameter Update, UPU, data.
BB15. The method of any of embodiments BB1-BB8 and BB11-BB14, wherein the set of one or more information fields includes a field indicating that, or whether, the wireless device supports a certain parameter for UPU.
BB16. The method of any of embodiments BB1-BB15, wherein the transparent container acknowledges successful reception of the device configuration data by acknowledging a successful security check of the device configuration data.
BB17. The method of any of embodiments BB1-BB16, comprising any of the steps of any of embodiments B1-B32.

### Group X Embodiments

X1. A method performed by a core network node configured for use in a home network of a wireless device, the method comprising:
   receiving, from the wireless device, a transparent container that acknowledges successful reception by the wireless device of device configuration data from the home network, wherein the transparent container contains a set of one or more information fields and integrity protection data that protects the integrity of the set of one or more information fields.
X2. The method of embodiment X1, further comprising:
   transmitting, from the core network node to an authentication server in the home network, the transparent container or the set of one or more information fields contained in the transparent container; and
   receiving, from the authentication server, integrity checking information that either:
      indicates a result of a check by the authentication server of the integrity of the set of one or more information fields; or
      is usable by the core network node to check the integrity of the set of one or more information fields.
X3. The method of embodiment X2, wherein the integrity checking information indicates the result of a check by the authentication server of the integrity of the set of one or more information fields.
X4. The method of embodiment X2, wherein the integrity checking information is usable by the core network node to check the integrity of the set of one or more information fields.
X5. The method of embodiment X4, further comprising using the integrity checking information to check the integrity of the set of one or more information fields.
X6. The method of embodiment X5, wherein the integrity checking information comprises expected integrity protection data, and wherein said using comprises checking whether the expected integrity protection data corresponds to the integrity protection data contained in the transparent container.
X7. The method of any of embodiments X1-X6, wherein the core network node implements a unified data management, UDM, function.
X8. The method of any of embodiments X1-X7, wherein the transparent container contains a header, wherein the header includes at least one information field in the set of one or more information fields, and wherein the integrity protection data protects the integrity of the set of one or more information fields by integrity protecting the header.
X9. The method of any of embodiments X1-X8, wherein the transparent container contains a header and a body, wherein the body includes at least one information field in the set of one or more information fields, and wherein the integrity protection data protects the integrity of the set of one or more information fields by integrity protecting the at least one information field in the body.
X10. The method of any of embodiments X1-X9, wherein the transparent container contains a header and a body, wherein the header includes at least one information field in the set of one or more information fields, and wherein the body includes at least one information field in the set of one or more information fields, and wherein the integrity protection data protects the integrity of the set of one or more information fields by integrity protecting the at least one information field included in the header and the at least one information field included in the body.
X11. The method of any of embodiments X1-X10, wherein the device configuration data includes steering of roaming information, wherein the steering of roaming information comprises information for encouraging the wireless device to roam to a preferred roamed-to-network indicated by the home network.
X12. The method of any of embodiments X1-X11, wherein the set of one or more information fields includes an information field that indicates the wireless device supports steering of roaming connected mode control information, wherein the steering of roaming connected mode control information comprises information to control timing for the wireless device to move from connected mode to idle mode in order to perform steering of roaming.
X13. The method of any of embodiments X1-X10, wherein the device configuration data includes a set of one or more device parameters.
X14. The method of embodiment X13, wherein the set of one or more device parameters includes:
   a parameter that indicates default configured network slice selection assistance information, NSSAI; and/or
   a parameter that indicates routing indicator data.
X15. The method of any of embodiments X1-X10 and X13-X14, wherein the set of one or more information fields includes an information field indicating that, or whether, the wireless device supports a certain device parameter from the home network.
X16. The method of any of embodiments X1-X10 and X13-X15, wherein the device configuration data includes User Equipment, UE, Parameter Update, UPU, data.
X17. The method of any of embodiments X1-X10 and X13-X16, wherein the set of one or more information fields includes a field indicating that, or whether, the wireless device supports a certain parameter for UPU.
X18. The method of any of embodiments X1-X17, wherein the transparent container acknowledges successful reception of the device configuration data by acknowledging a successful security check of the device configuration data.
1. A method performed by a core network node configured for use in a home network of a wireless device, the method comprising:
   transmitting, from the core network node to an authentication server in the home network, a transparent container or a set of one or more information fields contained in the transparent container, wherein the transparent container acknowledges successful reception by the wireless device of device configuration data from the home network; and
   receiving, from the authentication server, integrity checking information that either:
      indicates a result of a check by the authentication server of the integrity of the set of one or more information fields; or
      is usable by the core network node to check the integrity of the set of one or more information fields.
2. The method of embodiment 1, comprising the steps of any of embodiments X1-X18.
X1. A method performed by a core network node configured for use in a home network of a wireless device, the method comprising:
   receiving, from the wireless device, a transparent container that acknowledges successful reception by the wireless device of device configuration data from the home network, wherein the transparent container contains integrity protection data; and
   checking whether the integrity protection data corresponds to first expected integrity protection data or second expected integrity protection data, depending respectively on whether the transparent container contains a set of one or more information fields.
X2. The method of embodiments X1, wherein the core network node implements a unified data management, UDM, function.
X3. The method of any of embodiments X1-X2, wherein the transparent container contains a header, wherein the header includes at least one information field in the set of one or more information fields.
X4. The method of any of embodiments X1-X3, wherein the transparent container contains a header and a body, and wherein the body includes at least one information field in the set of one or more information fields.
X5. The method of any of embodiments X1-X4, wherein the device configuration data includes steering of roaming information, wherein the steering of roaming information comprises information for encouraging the wireless device to roam to a preferred roamed-to-network indicated by the home network.
X6. The method of any of embodiments X1-X5, wherein the set of one or more information fields includes an information field that indicates the wireless device supports steering of roaming connected mode control information, wherein the steering of roaming connected mode control information comprises information to control timing for the wireless device to move from connected mode to idle mode in order to perform steering of roaming.
X7. The method of any of embodiments X1-X4, wherein the device configuration data includes a set of one or more device parameters.
X8. The method of embodiment X7, wherein the set of one or more device parameters includes:
   a parameter that indicates default configured network slice selection assistance information, NSSAI; and/or
   a parameter that indicates routing indicator data.
X9. The method of any of embodiments X1-X4, wherein the set of one or more information fields includes an information field indicating that, or whether, the wireless device supports a certain device parameter from the home network.
X10. The method of any of embodiments X1-X4 and X7-X9, wherein the device configuration data includes User Equipment, UE, Parameter Update, UPU, data.
X11. The method of any of embodiments X1-X4 and X7-X10, wherein the set of one or more information fields includes a field indicating that, or whether, the wireless device supports a certain parameter for UPU.
X12. The method of any of embodiments X1-X11, wherein the transparent container acknowledges successful reception of the device configuration data by acknowledging a successful security check of the device configuration data.

### Group C Embodiments

C1. A wireless device configured to perform any of the steps of any of the Group A embodiments.
C2. A wireless device comprising processing circuitry configured to perform any of the steps of any of the Group A embodiments.
C3. A wireless device comprising:
   communication circuitry; and
   processing circuitry configured to perform any of the steps of any of the Group A embodiments.
C4. A wireless device comprising:
   processing circuitry configured to perform any of the steps of any of the Group A embodiments; and
   power supply circuitry configured to supply power to the wireless device.
C5. A wireless device comprising:
   processing circuitry and memory, the memory containing instructions executable by the processing circuitry whereby the wireless device is configured to perform any of the steps of any of the Group A embodiments.
C6. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C7. A computer program comprising instructions which, when executed by at least one processor of a wireless device, causes the wireless device to carry out the steps of any of the Group A embodiments.
C8. A carrier containing the computer program of embodiment C7, wherein the carrier is one of an electronic signal, optical signal, radio signal, or computer readable storage medium.
C9. An authentication server configured to perform any of the steps of any of the Group B embodiments.
C10. An authentication server comprising processing circuitry configured to perform any of the steps of any of the Group B embodiments.
C11. An authentication server comprising:
   communication circuitry; and
   processing circuitry configured to perform any of the steps of any of the Group B embodiments.
C12. An authentication server comprising:
   processing circuitry configured to perform any of the steps of any of the Group B embodiments;
   power supply circuitry configured to supply power to the authentication server.
C13. An authentication server comprising:
   processing circuitry and memory, the memory containing instructions executable by the processing circuitry whereby the authentication server is configured to perform any of the steps of any of the Group B embodiments.
C14. A computer program comprising instructions which, when executed by at least one processor of an authentication server, causes the authentication server to carry out the steps of any of the Group B embodiments.
C15. A carrier containing the computer program of any of embodiments C15-C16, wherein the carrier is one of an electronic signal, optical signal, radio signal, or computer readable storage medium.
C16. A core network node configured to perform any of the steps of any of the Group X embodiments.
C17. A core network node comprising processing circuitry configured to perform any of the steps of any of the Group X embodiments.
C18. A core network node comprising:
   communication circuitry; and
   processing circuitry configured to perform any of the steps of any of the Group X embodiments.
C19. A core network node comprising:
   processing circuitry configured to perform any of the steps of any of the Group X embodiments;
   power supply circuitry configured to supply power to the core network node.
C20. A core network node comprising:
   processing circuitry and memory, the memory containing instructions executable by the processing circuitry whereby the core network node is configured to perform any of the steps of any of the Group X embodiments.
C21. A computer program comprising instructions which, when executed by at least one processor of a core network node, causes the core network node to carry out the steps of any of the Group X embodiments.
C22. A carrier containing the computer program of any of embodiments C15-C16, wherein the carrier is one of an electronic signal, optical signal, radio signal, or computer readable storage medium.

1.-35. (canceled)

36. A method performed by an authentication server configured for use in a home network of a wireless device, the method comprising:
generating expected integrity protection data for checking an integrity of a set of one or more information fields contained in a transparent container that acknowledges successful reception by the wireless device of device configuration data from the home network; and
checking, or assisting a core network node in the home network to check, the integrity of the set of one or more information fields using the expected integrity protection data.

37. The method of claim 36, wherein the transparent container contains a header and a body, wherein:
the header includes at least one information field in the set of one or more information fields, wherein said generating comprises generating the expected integrity protection data from the at least one information field included in the header;
and/or the body includes at least one information field in the set of one or more information fields, wherein said generating comprises generating the expected integrity protection data from the at least one information field included in the body.

38. The method of claim 37, wherein generating the expected integrity protection data from the at least one information field included in the header comprises generating the expected integrity protection data from the header.

39. The method of claim 37, wherein the body includes the integrity protection data, and wherein generating the expected integrity protection data from the at least one information field included in the body comprises generating the expected integrity protection data from all of the body except the integrity protection data.

40. The method of claim 36, wherein said generating comprises generating the expected integrity protection data from the whole transparent container except for the integrity protection data.

41. The method of claim 36, wherein the device configuration data includes:
steering of roaming information, wherein the steering of roaming information comprises information for encouraging the wireless device to roam to a preferred roamed-to-network indicated by the home network;
an information field that indicates the wireless device supports steering of roaming connected mode control information, wherein the steering of roaming connected mode control information comprises information to control timing for the wireless device to move from connected mode to idle mode in order to perform steering of roaming; and/or
a set of one or more device parameters, wherein the set of one or more device parameters includes:
a parameter that indicates default configured network slice selection assistance information (NSSAI); and/or
a parameter that indicates routing indicator data.

42. The method of claim 36, wherein the set of one or more information fields includes:
an information field indicating that, or whether, the wireless device supports a certain device parameter from the home network; and/or
a field indicating that, or whether, the wireless device supports a certain parameter for UPU.

43. The method of claim 36, wherein said generating comprises generating the expected integrity protection data from the set of one or more information fields.

44. The method of claim 43, wherein generating the expected integrity protection data comprises:
forming an input to a key derivation function from a set of input parameters, wherein the set of input parameters includes at least the set of one or more information fields;
calculating an output of the key derivation function with the formed input; and
generating the expected integrity protection data from the output of the key derivation function.

45. The method of claim 36, further comprising receiving the transparent container, or the set of one or more information fields, from the core network node, as received by the core network node from the wireless device.

46. The method of claim 45, wherein said generating comprises generating the expected integrity protection data from the transparent container, or the set of one or more information fields, received from the core network node.

47. The method of claim 36, wherein said generating comprises:
generating the expected integrity protection data after the home network receives the transparent container from the wireless device; or
before the home network receives the transparent container from the wireless device, generating the expected integrity protection data from an expected transparent container, or an expected set of one or more information fields, that is expected to be received by the home network from the wireless device.

48. A method performed by a core network node configured for use in a home network of a wireless device, the method comprising:
transmitting, from the core network node to an authentication server in the home network, a transparent container or a set of one or more information fields contained in the transparent container, wherein the transparent container acknowledges successful reception by the wireless device of device configuration data from the home network; and
receiving, from the authentication server, integrity checking information that either:
indicates a result of a check by the authentication server of the integrity of the set of one or more information fields; or
is usable by the core network node to check the integrity of the set of one or more information fields.

49. The method of claim 48, wherein the integrity checking information is usable by the core network node to check the integrity of the set of one or more information fields, wherein the method further comprises using the integrity checking information to check the integrity of the set of one or more information fields.

50. The method of claim 49, wherein the integrity checking information comprises expected integrity protection data, and wherein said using comprises checking whether the expected integrity protection data corresponds to the integrity protection data contained in the transparent container.

51. The method of claim 48, wherein the transparent container contains a header and a body, wherein:
the header includes at least one information field in the set of one or more information fields, wherein the integrity protection data protects the integrity of the set of one or more information fields by integrity protecting the at least one information field included in the header; and/or
the body includes at least one information field in the set of one or more information fields, wherein the integrity protection data protects the integrity of the set of one or more information fields by integrity protecting the at least one information field included in the body.

52. The method of claim 48, wherein the device configuration data includes:
steering of roaming information, wherein the steering of roaming information comprises information for encouraging the wireless device to roam to a preferred roamed-to-network indicated by the home network;
an information field that indicates the wireless device supports steering of roaming connected mode control information, wherein the steering of roaming connected mode control information comprises information to control timing for the wireless device to move from connected mode to idle mode in order to perform steering of roaming; and/or
a set of one or more device parameters, wherein the set of one or more device parameters includes:
a parameter that indicates default configured network slice selection assistance information (NSSAI); and/or
a parameter that indicates routing indicator data.

53. The method of claim 48, wherein the set of one or more information fields includes:
an information field indicating that, or whether, the wireless device supports a certain device parameter from the home network; and/or
a field indicating that, or whether, the wireless device supports a certain parameter for UPU.

54. A method performed by a wireless device, the method comprising:
receiving device configuration data from a home network of the wireless device; and
transmitting a transparent container that acknowledges successful reception of the device configuration data, contains a set of one or more information fields, and contains integrity protection data that integrity protects the set of one or more information fields.

55. The method of claim 54, wherein the set of one or more information fields includes:
an information field indicating that, or whether, the wireless device supports a certain device parameter from the home network; and/or
a field indicating that, or whether, the wireless device supports a certain parameter for UPU.

56. An authentication server configured for use in a home network of a wireless device, the authentication server comprising:
communication circuitry; and
processing circuitry configured to:
generate expected integrity protection data for checking an integrity of a set of one or more information fields contained in a transparent container that acknowledges successful reception by the wireless device of device configuration data from the home network; and
check, or assist a core network node in the home network to check, the integrity of the set of one or more information fields using the expected integrity protection data.
